(19) United States
(12) Patent Application Publication
(10) Pub. No.: US 2019/0197625 A1
(43) Pub. Date: Jun. 27, 2019

(54) METHOD AND SYSTEM FOR TRADING FINANCIAL DERIVATIVES

(71) Applicant: Steven Marc Reiter, Herzliya (IL)

(72) Inventor: Steven Marc Reiter, Herzliya (IL)

(21) Appl. No.: 16/215,677

(22) Filed: Dec. 11, 2018

Related U.S. Application Data
(60) Provisional application No. 62/597,837, filed on Dec. 12, 2017.

(51) Int. Cl. G06Q 40/06; G06F 16/904

(52) U.S. Cl. CPC G06Q 40/06; G06F 16/904

(57) ABSTRACT

Methods and system provided present information for trading of financial instruments and their derivatives, such as options trading, in an easily and intuitively understood manner. The system provides an intuitive interface to allow users to understand and manipulate complex trading and analysis on smartphones, tablets, and personal computers. The system has a date slider, a profit and loss chart, and a limit panel intuitively displayed and that move in conjunction with each other to allow traders too quickly and visually interpret information. The system combines both historical charts and a measure of the risk of a trade (a profit and loss chart) in a frame that shows a relevant range of future outcomes for the asset and time horizon chosen (a range of confidence), as well as the limit slider to define open and close limits.

### RELATED APPLICATION

This application claims priority to U.S. Provisional Application No. 62/597,837 entitled “Trading Application for Financial Derivatives” by Steven Marc Reiter, filed Dec. 12, 2017, which is incorporated by reference herein.

### FIELD OF THE INVENTION

The present application relates to trading of financial instruments and derivatives such as options on financial instruments, and related user interfaces for computers including mobile devices, tablets, and computers. More specifically, the application relates to user interfaces for analysis and trading of financial instruments and derivatives of financial instruments, such as options

### BACKGROUND

Financial trading such as trading options on financial instruments (e.g., stocks or foreign exchange rates) can be complex. Complex trading tools are typically not presented in a way that is easily understandable and able to be manipulated by a user. Most conventional trading platforms offer trade entry using numbers, and they may also offer charting tools. Some even allow a trader to enter orders by clicking on a chart. But conventional trading tools do not satisfy a trader's need to understand complex products like options, and they do not offer an intuitive and easy process for users who trade options. Conventional systems do not present such a complex product (options on financial instruments) in a way that is easily understood by traders without sacrificing functionality.

For example, conventional trading platforms do not offer an interface for trading options that combines both historical charts and a measure of the risk of a trade in a frame that shows a relevant range of future outcomes for the asset and time horizon chosen. They do not show how these aspects change as the user changes the variables of a potential option trade. They offer no interactive hints of the consequence of changing these variables which could help the user understand the interplay, or exchange, of risk and reward in the trading of financial instruments.

As another example, for pending orders, conventional platforms force the trader to define limit orders for financial instruments in terms of price or profit and loss. They do not offer a method of setting opening and/or closing order levels that provides the user with feedback on the validity of the orders level or levels, context relative to historical trading ranges, and simultaneous calculation of profit and loss potential, displayed graphically and numerically. Conventional systems do not allow traders of options to define limits overlaid on a historical price chart in terms of price, while seeing the resulting profit and loss on the profit and loss diagram, taking the guesswork out of setting up a trade, and showing how the order level, historical price chart, and profit and loss are related. These conventional systems also typically do not present trade entry features and colors to reduce the chance of entering an unintended trade, giving the user a total picture with all the visual cues needed to understand the transaction. Nor do they generally prevent a user from attempting to enter an invalid order to trade.

Consequently, it is desirable to have a method and system to avoid these and other related problems, to bring intuitiveness to the trading interface.

### SUMMARY

A method in a data processing for trading a derivative of a financial instrument is provided comprising displaying a profit and loss chart showing a profit or loss for a trade of a derivative of the financial instrument on a display, and displaying a time slider that a user can move on the display. The method further comprises displaying a limit slider that the user can move on the display, and receiving an indication of movement of the time slider from the user. The method also comprises updating the profit and loss chart in response to the indication of movement of the time slider from the user, and displaying the updated profit and loss chart on the display.

A data processing system for trading a derivative of a financial instrument is provided comprising a display, and a processor configured to execute instructions stored in a memory. The memory stores the instructions that, when executed by the processor, cause the processor to display a profit and loss chart showing the profit or loss for a trade of a derivative of the financial instrument on the display, and display a time slider that a user can move on the display. The instructions also cause the processor to display a limit slider that the user can move on the display, and receive an indication of movement of the time slider from the user. The instructions further cause the processor to update the profit and loss chart in response to the indication of movement of the time slider from the user, and display the updated profit and loss chart on the display.

A method in a data processing for trading an option on a stock is provided, comprising displaying a profit and loss chart showing the profit or loss for a trade of the option on a display, and displaying a time slider that a user can move on the display. The method further comprises displaying a limit slider that the user can move on the display, displaying a historical data chart; and displaying a range of confidence indicator. The method also comprises receiving an indication of movement of the time slider from the user, updating the profit and loss chart, range of confidence indicator, and historical data chart in response to the indication of movement of the time slider from the user. Finally, the method comprises displaying the updated profit and loss chart on the display.

### BRIEF DESCRIPTION OF THE DRAWINGS

FIG. 1 illustrates a computer 100 in accordance with one embodiment.

FIG. 2 illustrates a trading system 200 in accordance with one embodiment.

FIG. 3 illustrates a trading page 300 in accordance with one embodiment.

FIG. 4 illustrates a layout 400 of a trading page 300 in accordance with one embodiment.

FIG. 5 illustrates a time slider panel 500 in accordance with one embodiment.

FIG. 6 illustrates a profit-and-loss chart 600 in accordance with one embodiment.

FIG. 7 illustrates a limit panel 700 in accordance with one embodiment.

FIG. 8 illustrates a historical data panel 800 in accordance with one embodiment.

FIG. 9 illustrates a range of confidence panel 900 in accordance with one embodiment.

FIG. 10 illustrates a strike price slider panel 1000 in accordance with one embodiment.

FIG. 11 illustrates a buy-sell panel 1100 in accordance with one embodiment.

FIG. 12 illustrates a strategy selector page 1200 in accordance with one embodiment.

FIGS. 13-17 illustrate the trading page responding to a change from one strategy to another in accordance with one embodiment.

FIGS. 18-22 illustrate how the trading page responds to movement of the time slider handle in accordance with one embodiment.

FIGS. 23-32 illustrate the profit and loss chart updating when the sell panel is activated and the buy panel is deactivated in accordance with one embodiment.

FIGS. 33-42 illustrate a limit panel in accordance with one embodiment.

FIG. 43 illustrates a spot trade with limit orders in accordance with one embodiment.

FIG. 44 illustrates a method for trading a derivative of a financial instrument, in accordance with one embodiment.

### DETAILED DESCRIPTION

A glossary is provided for information on several terms.

“Buy limit order” refers to an order to purchase a financial instrument at or below a specified price.

“Buy stop order” refers to an order to purchase at market prices a financial instrument if it trades at a price that is higher than the current market price.

“Call option (or simply, “call”)” refers to an agreement that gives the option buyer the right (but not the obligation) to buy a specified amount of a stock, bond, commodity, or other financial instrument at a specified price within a specific time period, or at a specific agreed time and date. The stock, bond, commodity, or other financial instrument is called the underlying asset.

“Delta” refers to a ratio comparing the change in the price of an asset, usually an option on a marketable security, to the corresponding change in the price of the underlying asset. For example, if a stock option has a delta value of 0.65, this means that if the underlying stock increases in price by $1 per share, the option on it will rise by $0.65 per share.

“Derivative” refers to a financial product, such as an option, that derives its value from an underlying asset, such as a financial product.

“Handle (or “handler”)” refers to a user-interface element by which a user can specify an input or feature moving the element across a range.

“Implied volatility” refers to the future volatility of an underlying financial instrument's price as determined by market prices for an option on that underlying instrument, calculated using option prices and other market observed variables and an options pricing model.

“Pip” refers to a defined change in price according to market convention for the respective financial instrument. For most foreign exchange rates, or currency pairs, this is the equivalent of 1/100 of 1%, or one basis point. For example, conventionally, the pip definition for the USD/CAD currency pair is $0.0001, or one basis point. For USD/JPY, one pip is 0.01. Most currency pairs are quoted to an accuracy of one tenth of one pip.

“Put option (or simply, “put”)” refers to an option contract giving the owner the right (but not the obligation) to sell a specified amount of a stock, bond, commodity, or other financial instrument at a specified price within a specified time period, or at a specific future time and date. The stock, bond, commodity, or other financial instrument is called the underlying asset.

“Slider” refers to an interface design for choosing a discrete point along a defined range. In various embodiments, ranges are defined for strike prices, limit prices, and expiration dates. In various embodiments, each slider has one, two, three, four, or more handles or handlers for a user to specify inputs or features relevant to the trading of financial instruments along the relevant slider.

“Stop loss order” refers to an order to close or unwind a position in a financial instrument at market prices when it reaches a specified price that is worse than the current price, thereby preventing further losses. A “Stop order” is a similar order for establishing a position at a price that is worse than the current market price, setting a limit on the market price “getting away” from the trader.

“Strike price” refers to the price at which a derivative contract can be exercised. For a call option, the strike price is the price at which the security can be bought by the option buyer until the expiration date (or on the expiration date, depending on the type of option traded). For a put option, the strike price is the price at which the security can be sold by the option buyer until the expiration date, or on the expiration date.

“Take profit order” refers to an order that specifies an exact price at which to close a position in a financial instrument for a profit, or at a price that is better than the current marked price for the instrument

“Tenor” refers to the amount of time until a derivative financial contract, such as an option, expires.

“Vega” refers to a measurement of an option's sensitivity to changes in the volatility of the underlying asset.

Methods and system in accordance with the present disclosure present information for trading of financial instruments and their derivatives, such as options trading, in a way that may be easily and intuitively understood by users such as traders, while providing clarity, accuracy and functionality. They allow users without advanced knowledge to understand complex trading instruments and risk, and perform potentially complex trading on familiar devices, such as smartphones, tablets, and personal computers.

The system provides an intuitive interface for the easy understanding and manipulation of inputs by traders for the determination of trading strategies, such that the trader is able to enter financial transactions that meet his or her market view or hedging requirement. The system includes features and controls that enhance the user experience for the exploration, pricing, and trading of financial instruments on, for example, mobile, tablet, and desktop computers. More specifically, the system provides trading and analysis of financial instruments and options on financial instruments, the combination of which often requires advanced knowledge on the part of the user. The system presents these instruments in a clear fashion, with intuitive interactivity, enabling novice and experienced traders alike to understand complex trading, and to analyze the risk exposure of portfolios of such financial instruments.

In one implementation, the system combines both historical charts and a measure of the risk of a trade (the profit and loss chart described below) in a frame that shows a relevant range of future outcomes for the asset and time horizon chosen (the range of confidence described further below). The profit and loss chart is a bar chart showing the net profitability of a trade on its horizon date at the levels of the underlying asset price shown on the y-axis. The profit and loss chart uses colors to show net profit (in green) and loss (in red) with numerical representation at intervals along the chart. The numerical representation offers additional functionality, as the user can toggle from profit and loss numbers in terms of the underlying asset price, e.g., 50 pips of profit, or in terms of the account currency, e.g., profit of USD 234.50, or in terms of the currency of the asset traded, e.g., EUR 198.76. The horizon date is determined by the user using the expiration date slider (the time slider panel discussed below.) Users may manipulate the sliders to see how the information and predictions change in real-time as they are moved. Limit sliders are also provided that allow the user to define open and close limits for the user's strategy. The system shows clearly how the profit and loss chart, range of confidence arc, expiration date slider and limit sliders move in conjunction with each other as the user changes assumptions about the potential trade, and as the market price of the underlying asset continues to change while the user is setting up his trade. This complete live interactivity enhances the user's understanding of the risk and potential reward of his transaction.

The graphical interface allows traders to define limits overlaid on a historical price chart in terms of price, while seeing the resulting profit/loss on the profit and loss chart, taking the guesswork out of setting up a trade, and showing how the order level, historical price chart, and profit and loss are related. The trade entry features and colors reduce the chance of entering an unintended trade, as the total picture gives the user all the visual cues needed to understand the transaction. In one implementation, the application does not allow a user to enter invalid orders such as buy limit orders above the current market price, nor does it allow a user to enter two entry limit orders, or two closing take profit orders. Option limit orders can be entered in terms of the underlying asset price or in terms of the total price of the option in the account currency or the asset's quoted currency.

Further, the system provides live streaming pricing to help complete the picture and let the trader understand the transaction being set up, enabling execution of the trade that meets the trader's market view. The system allows the user to trade financial assets as well as options on the financial assets, with the most common option trading strategies easily deployed.

The system may present a page for a user to enter, close or modify transactions in financial instruments and derivatives of financial instruments. This interface combines historical data with future expected ranges of outcome, and a set of interactive tools for defining a trade or strategy with automated calculations of prices, risk, margin requirements, and overall strategy profit and loss over any range of potential outcomes.

In one embodiment, a trading screen includes a date slider, a historical price chart, a profit and loss chart, and a limit panel. The trading screen dynamically updates in response to changes in the date slider. For spot trading, the date slider may be used to expand or contract the historical range shown on the trading screen (which, for example, can also be achieved by pinch and zoom). For option trading, the time slider may be used to expand or contract not only the historical range shown on the trading screen but also a range of confidence for predicted future price levels based on the tenor specified in the time slider, the implied volatility of options on the underlying asset, and interest rates. The trading screen may automatically scale to fill the available horizontal and vertical space on a device screen, making efficient use of limited space, which may be especially beneficial when using a device having a smaller screen such as a smartphone or tablet.

The profit and loss chart is provided to correspond to a selected trading strategy. A horizon date is set using the date slider. The profit and loss chart shows the net profitability of a trade on its horizon date at the levels of the underlying asset price shown on the Y-axis. The profit and loss chart may change dynamically with changes in the live streaming price of underlying assets, changes in the strike price(s), changes in limit levels (if any) for entering the market, and changes between buying and selling. The profit and loss chart may use color coding to permit the user to quickly and easily interpret the effect of a change in any of the underlying parameters.

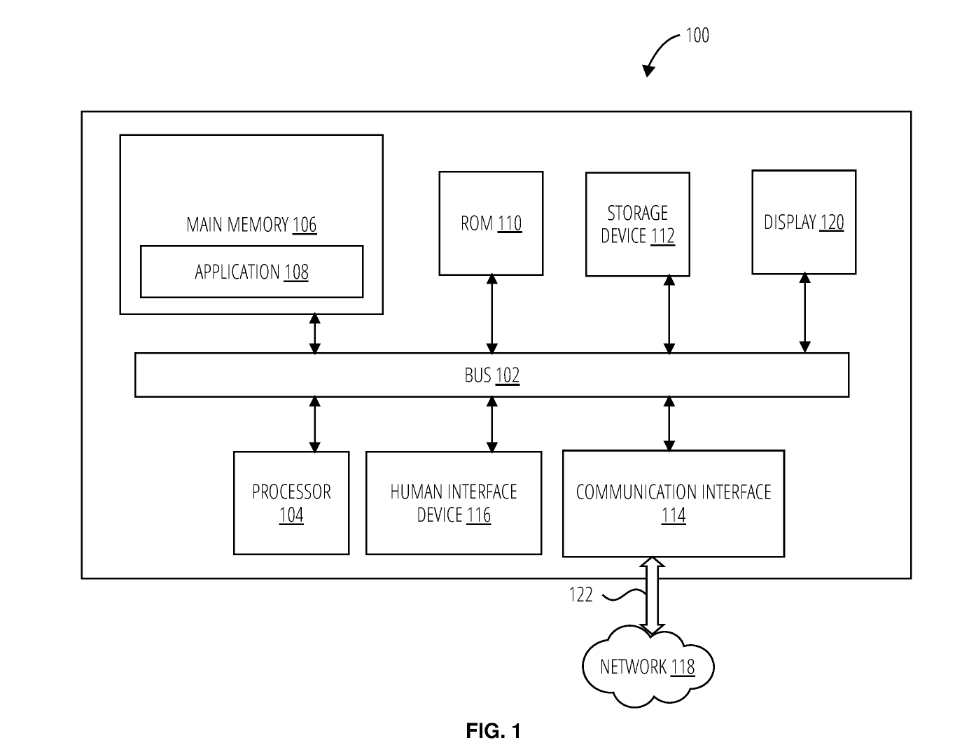

FIG. 1 shows a computer 100 in accordance with an embodiment. Computer 100 includes a bus 102 or other communication mechanism for communicating information, and a processor 104 coupled with bus 102 for processing the information. Computer 100 also includes a main memory 106, such as a random access memory (RAM) or other dynamic storage device, coupled to bus 102 for storing information and instructions to be executed by processor 104. In addition, main memory 106 may be used for storing temporary variables or other intermediate information during execution of instructions to be executed by processor 104. Main memory 106 includes a program or application 108 consistent with methods and systems of the present invention. Computer 100 further includes a read only memory (ROM 110) or other static storage device coupled to bus 102 for storing static information and instructions for processor 104. A storage device 112, such as a flash drive, hard drive or optical disk, is provided and coupled to bus 102 for storing information and instructions. Computer 100 further includes a human interface device 116, such as a capacitive touch screen, a resistive touch screen, a mouse, a joystick, a stylus, a trackball, or the like. Computer 100 further includes a display 120, such as a liquid crystal display (LCD) panel, an organic light-emitting diode (OLED) panel, or the like. According to various embodiments, computer 100 may be a personal computer, a server, a laptop, a smartphone, a wearable device, a mobile device, a tablet, smart glasses, or any other digital device equipped with appropriate input, output, and processing capabilities.

According to one embodiment, processor 104 executes one or more sequences of one or more instructions contained in main memory 106. Such instructions may be read into main memory 106 from another computer-readable medium, such as storage device 112. Execution of the sequences of instructions in main memory 106 causes processor 104 to perform the process steps described herein. One or more processors in a multi-processing arrangement may also be employed to execute the sequences of instructions contained in main memory 106. Thus, in some embodiments, the sequences of instructions configure the computer 100 to perform predetermined tasks, operations, programs, or applications. In alternative embodiments, hard-wired circuitry is used in place of or in combination with software instructions. Thus, embodiments are not limited to any specific combination of hardware circuitry and software.

Although described relative to main memory 106 and storage device 112, instructions and other aspects of methods and systems consistent with the present invention may reside on another computer-readable medium, such as a floppy disk, a flexible disk, hard disk, flash drive, CD-ROM, magnetic, optical, or physical medium, a RAM, a PROM, an EPROM, a FLASH-EPROM, any other memory chip or cartridge, or any other medium from which a computer can read.

Computer 100 also includes a communication interface 114 coupled to bus 102. Communication interface 114 provides a two-way data communication coupling to a network link 122 that is connected to a network 118, such as the Internet or other computer network. Wireless links may also be implemented. In any such implementation, communication interface 114 sends and receives signals that carry digital data streams representing various types of information.

In one implementation, computer 100 may operate as a client on network 118. In another implementation, computer 100 may operate as a server on network 118. Computer 100 may also represent other computers on the Internet, such as users' computers having web browsers, and the user's computers may have similar components as computer 100.

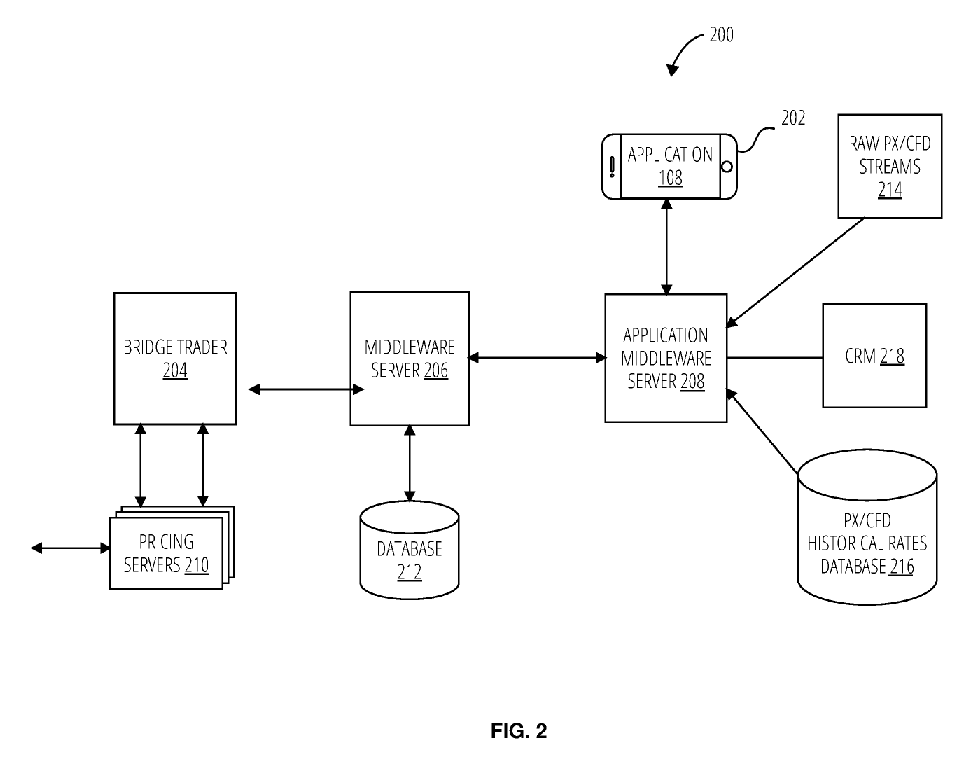

FIG. 2 shows a high-level overview of an exemplary trading system 200. The trading system 200 comprises a computer 202, a trading client 208, such as a ProTraderPlus Client, which is a trading application for end users. The trading system 200 also includes risk management 204, an application for managing proprietary risk, as well as a bridge trader 206, which may be a main server and databases for trading application, books and records of customer activity. The trading system 200 further includes an application 108, which may be an application for use on mobile phones and other devices. Further included is middleware server 210, a server for hosting risk management systems for managing positions executed by traders, and for handling communication between the mobile application middleware server 214. Application middleware server 214 handles connectivity and data exchange with the application 108, and interaction with middleware server 210, and pricing servers 216 are ancillary servers for market data collection and processing of options calculations. The database 218 includes storage of data required for the quick responsiveness of the mobile application on behalf of application middleware server 214. The trading system 200 also includes a raw FX/CFD (Foreign Exchange and Contracts for Differences) streams 220 which is a live market data provided by banks and brokers by FIX protocol (or may be any financial instrument live market price feeds), and a FX/CFD historical rates database 222 of historical prices and price chart data. Also provided is customer relationship management software and databases CRM 224.

The application 108 subscribes to aggregated and bespoke pricing information from a proprietary network of globally distributed servers so that it can offer a consistent, uninterrupted pricing experience to the user. Advanced mathematics are deployed in the application 108 itself so that it can operate quickly and efficiently. Two-way communication over one socket connection allows for continuous exchange of information on transactions, positions, markets, pricing, charts, and more.

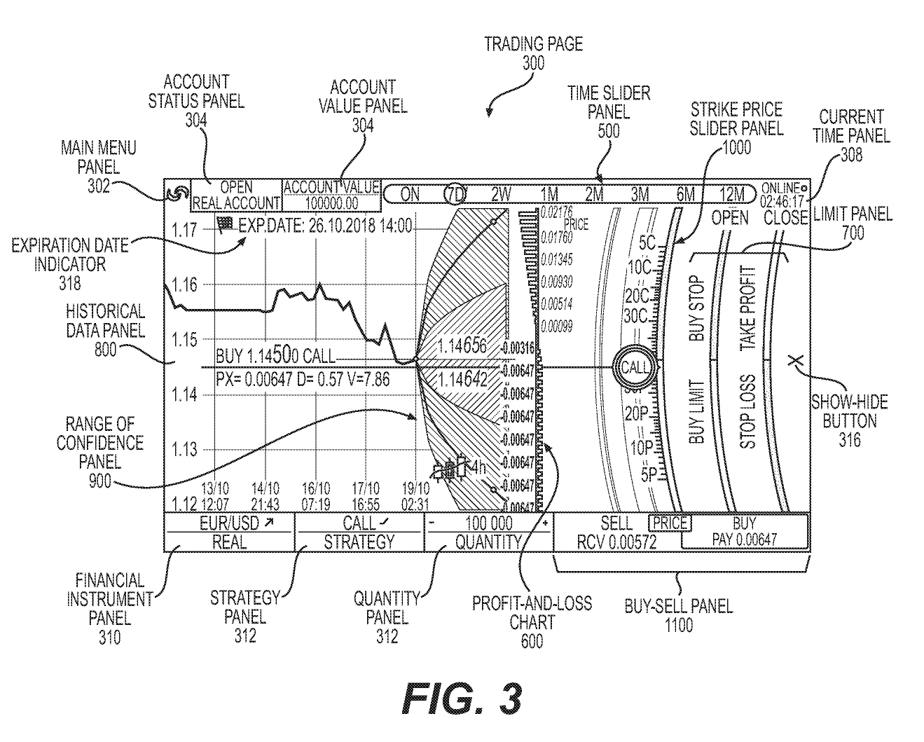

FIG. 3 shows a trading page 300 of application 108. The trading page 300 offers an intuitive page for a user to enter, close or modify transactions in financial instruments and derivatives of financial instruments. The application 108 includes an interface that combines historical data with a relevant range of future potential prices, as indicated with shaded areas of confidence, and a set of interactive tools for defining a trade or strategy with automated calculations of prices, risk, margin requirements, and overall strategy profit and loss over any range of potential outcomes.

The trading page 300 comprises a menu button 302, an account status button 304, an account value panel 306, a current time panel 308, a financial instrument panel 310, a strategy panel 312, a quantity panel 314, a show-hide button 316, a time slider panel 500, a profit-and-loss chart 600, a limit panel 700, a historical data panel 800, a range of confidence panel 900, a strike price slider panel 1000, and a buy-sell panel 1100.

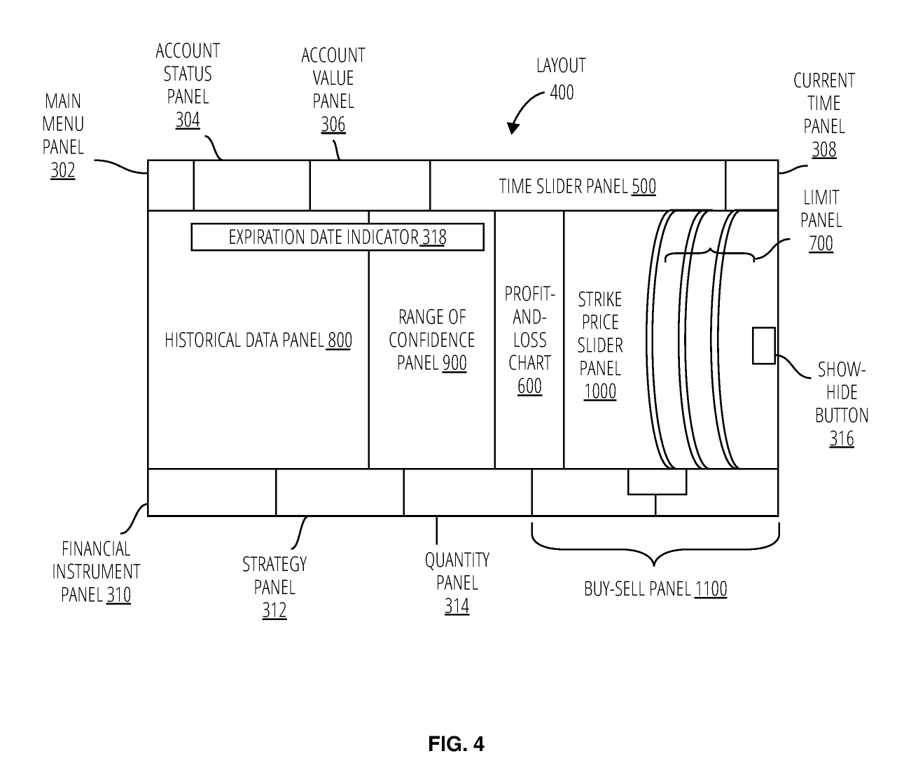

For additional clarity, a schematic layout 400 of the trading page 300 is shown in FIG. 4.

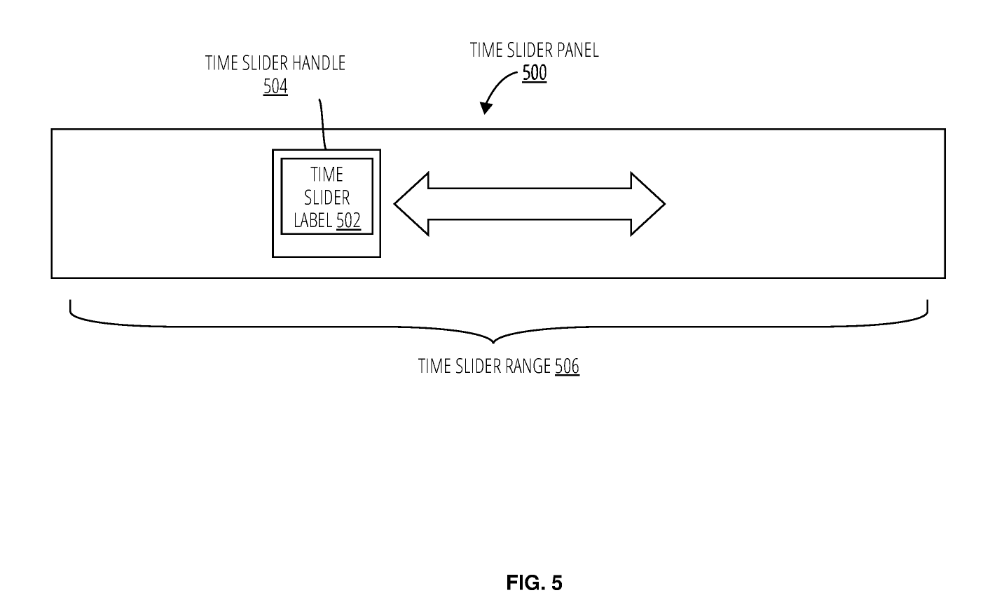

The time slider panel 500 is shown and discussed in greater detail with respect to FIG. 5.

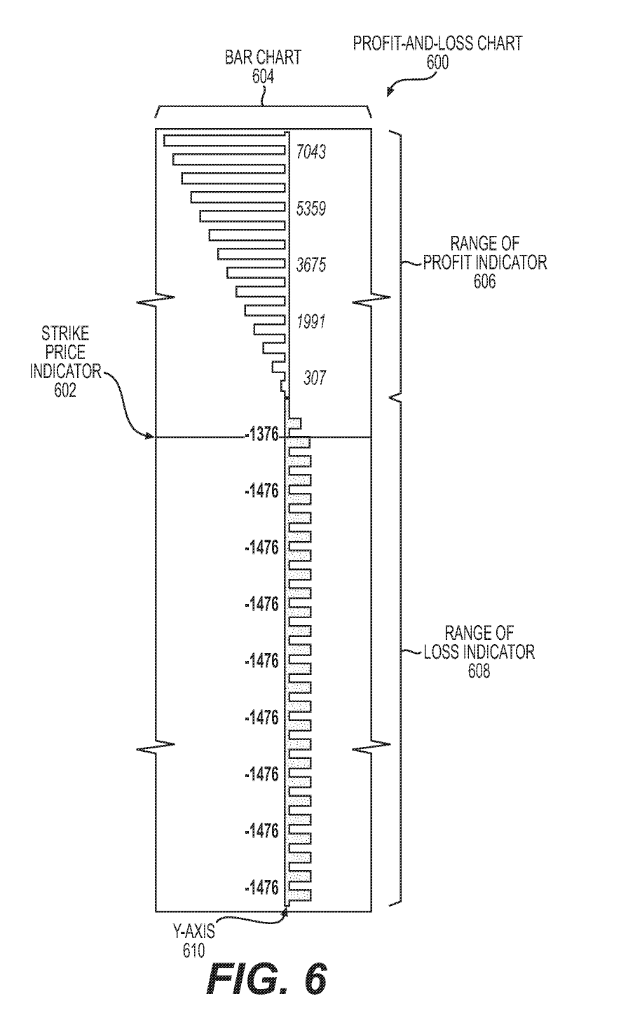

The profit-and-loss chart 600 is shown and discussed in greater detail with respect to FIG. 6.

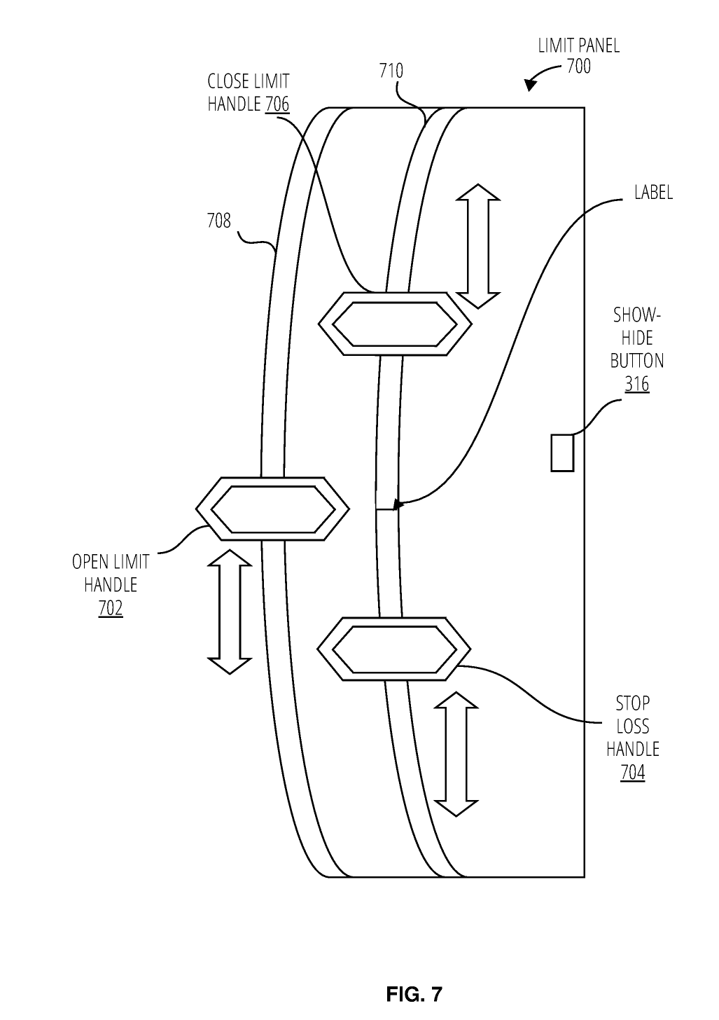

The limit panel 700 is shown and discussed in greater detail with respect to FIG. 7.

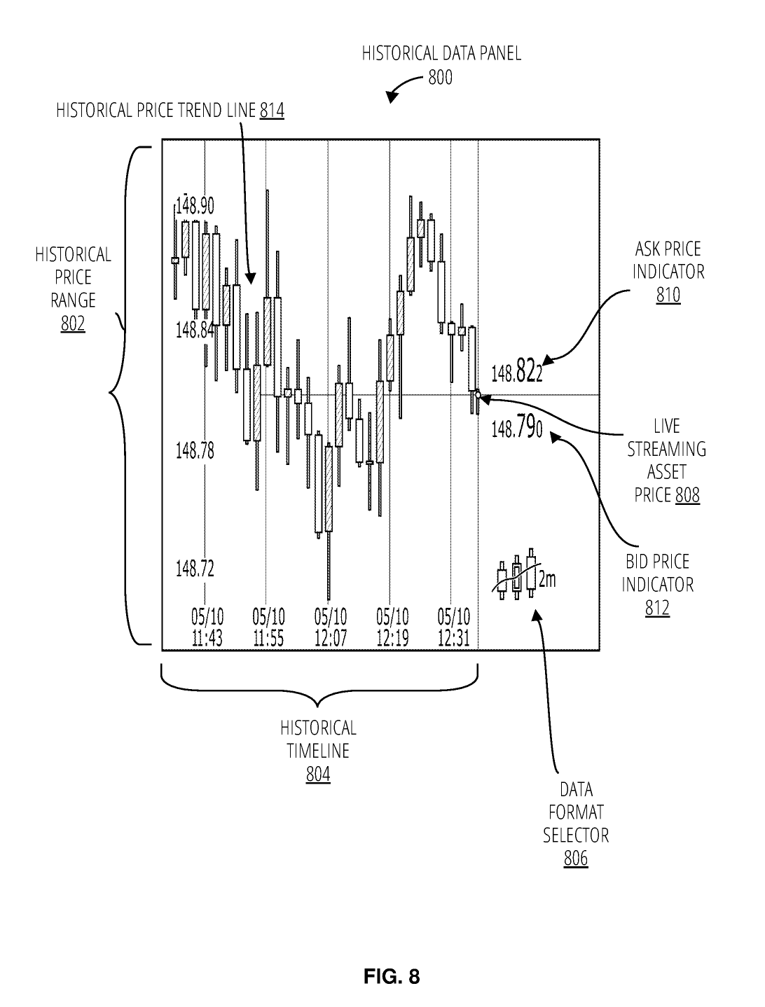

The historical data panel 800 is shown and discussed in greater detail with respect to FIG. 8.

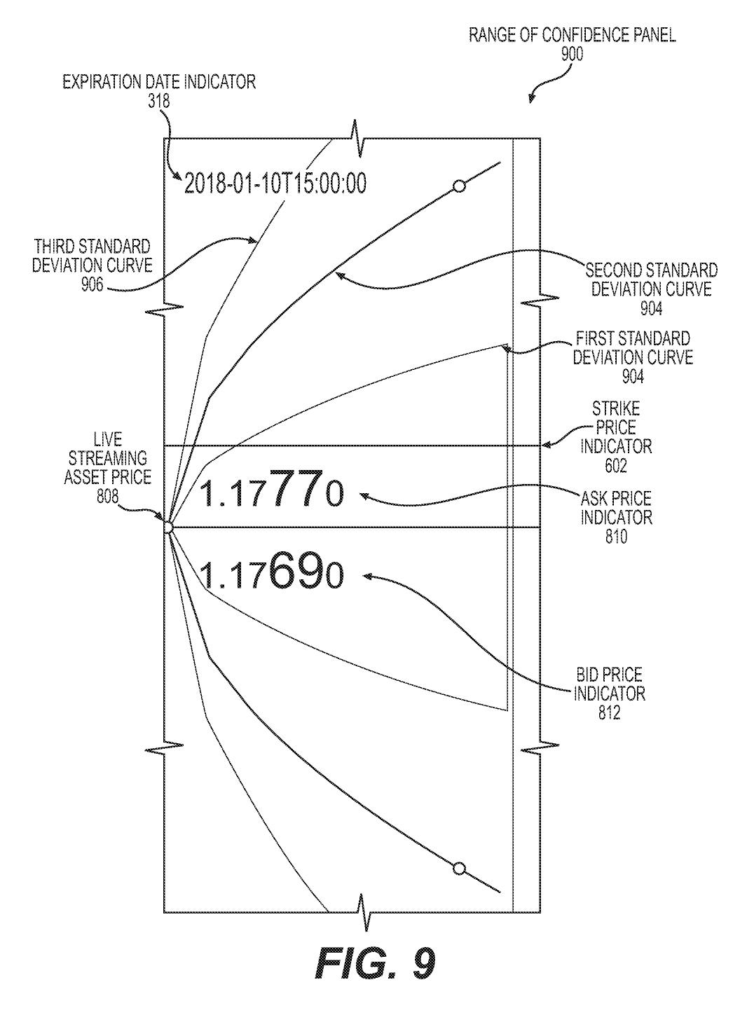

The range of confidence panel 900 is shown and discussed in greater detail with respect to FIG. 9.

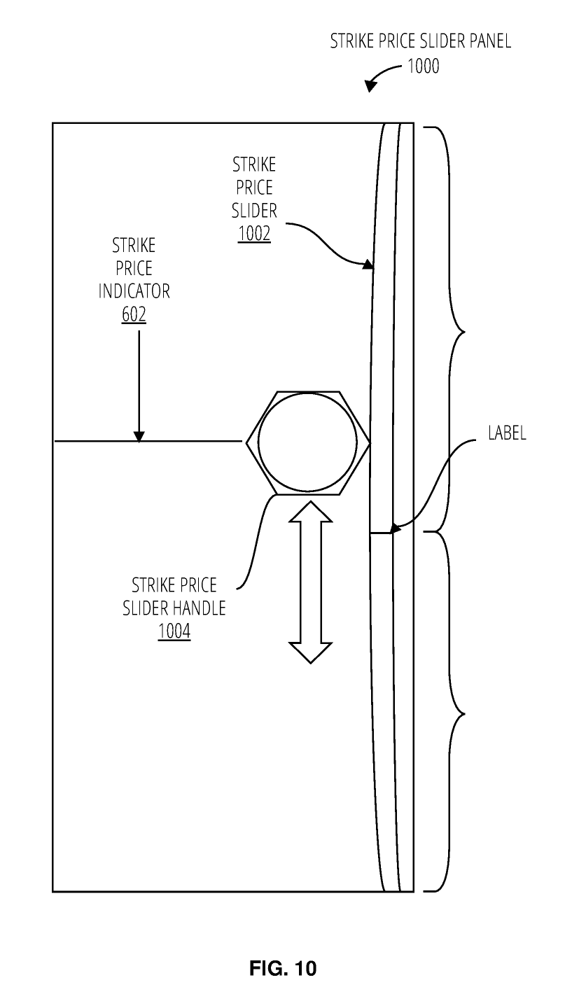

The strike price slider panel 1000 is shown and discussed in greater detail with respect to FIG. 10.

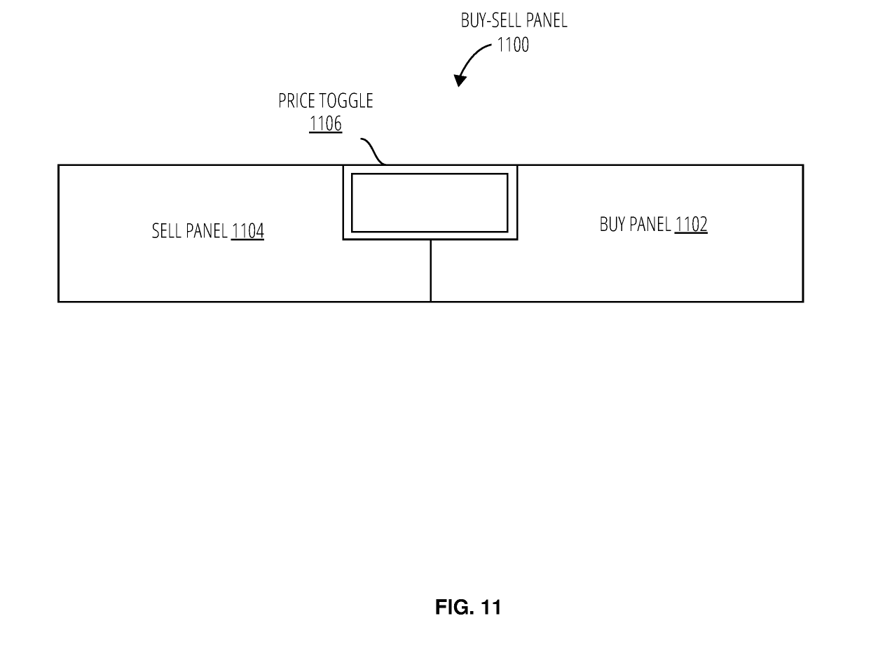

The buy-sell panel 1100 is shown in greater detail with respect to FIG. 11.

Tapping the main menu panel 302 in the top left corner of the trading page 300 causes a main menu page (not shown) to be displayed. The account status panel 304 to the right of the main menu panel 302 displays information pertaining to the status of the user's account, including a settings menu. The account value panel 306 to the right main menu panel 302 displays information pertaining to the value of assets in the user's account and use of available margin; touching this panel opens a new page with greater account detail, including risk information and access to open positions and pending orders, account history, and realized profit and loss reports. The time slider panel 500 extends along the top edge of the trading page 300, to the right of the account value panel 306. The current time panel 308 in the top right corner displays the current time and server connectivity status.

The financial instrument panel 310 is in the bottom left corner of the trading page 300. Tapping the financial instrument panel 310 causes a financial instrument selector page (not shown) to appear. The financial instrument selector page allows the user to select a currency pair or other underlying financial instrument, to see information about the currency pair or instrument such as the day's high and low prices, and previous day's closing price. It also allows selection of current and historical implied volatility data for each instrument and standard tenors, and definitions of pip values, trading sizes, interest charges, and other related important trading information.

The financial instrument panel 310 includes a financial instrument name to enable the user to quickly and easily verify what financial instrument is being displayed and potentially traded on the trading page 300. For example, as shown in FIG. 3, the financial instrument name “EUR/USD” is.displayed.

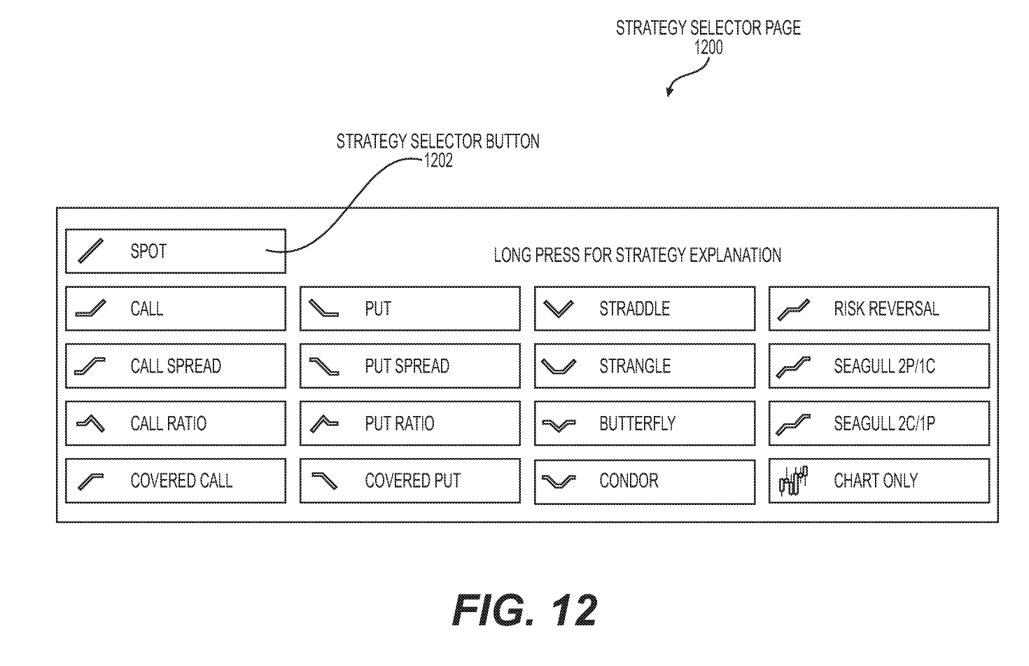

The strategy panel 312 is to the right of the financial instrument panel 310. Tapping the strategy panel 312 causes a strategy selector page 1200 to appear (see FIG. 12). The strategy panel 312 includes a strategy name and a strategy icon to enable the user to quickly and easily verify what strategy is being applied on the trading page 300. For example, as shown in FIG. 3, a “CALL” strategy is applied, as illustrated by the strategy icon.

The quantity panel 314 is to the right of the strategy panel 312. Tapping the quantity panel 314 causes a quantity selector panel to appear. The quantity panel 314 includes a quantity indicator to enable the user to quickly and easily verify the quantity of financial instruments to be analyzed, bought, or sold. For example, as shown in FIG. 3, a quantity of 100,000 assets is specified. The quantity selector panel includes a numerical keypad and various buttons to easily adjust the quantity to be traded or priced.

The buy-sell panel 1100 is in the bottom right corner of the trading page 300.

The live streaming asset price 808 is displayed as a point or crosshair at an intersection of time (x-axis) and price (y-axis). An ask price indicator 810 is displayed just above and to the right of the live streaming asset price 808. Likewise a bid price indicator 812 is displayed just below and to the right of the live streaming asset price 808. The live streaming asset price 808 is displayed at the right edge of the historical data panel 800. Where the range of confidence panel 900 is used, the live streaming asset price 808 is displayed at the left edge of the range of confidence panel 900. Thus, where both the historical data panel 800 and the range of confidence panel 900 are used, the live streaming asset price 808 is displayed in between them, for example as shown in FIG. 3.

When trading options or options strategies, the strike price slider panel 1000 is displayed on the right side of the trading page 300. The strike price slider handle 1004 is movable along the strike price slider 1002. The strike price indicator 602 extends horizontally across the trading page 300 across the historical data panel 800 on the left, across the live streaming asset price 808, across the range of confidence panel 900, and across the profit-and-loss chart 600, connecting to the strike price slider handle 1004. Alongside the strike price slider are labels showing deltas for various strikes along the slider, from the low strike of a put option with delta of −5% up to the high strike of a call option with delta of 5%, and at various levels in between. This helps the trader quickly understand the sensitivity of the option the trader is pricing to changes in the price of the underlying asset.

The show-hide button 316 is displayed on the far right edge of the trading page 300. This button opens and closes the limit panel 700, which is able to slide in and out of the right side of trading page 300. In some embodiments, when the limit panel 700 is hidden, the show-hide button 316 displays the word “LIMIT.” In some embodiments, when the limit panel 700 is shown, the show-hide button 316 displays an “X”, as shown in FIG. 3. Tapping the show-hide button 316 when the limit panel 700 is hidden causes the limit panel 700 to expand from the right edge of the trading page 300. Conversely, tapping the show-hide button 316 when the limit panel 700 is shown causes the limit panel 700 to retract into the right edge of the trading page 300. In one implementation, limits are only in effect if the limit panel is displayed. Closing the limit panel automatically cancels any limit levels that had been set.

FIG. 4 shows a layout 400 of the trading page 300. In an embodiment, elements of the trading page 300 from top left to top right include the main menu panel 302, the account status panel 304, the an account value panel 306, the time slider panel 500, the current time panel 308; elements of the trading page 300 from middle left to middle right include the historical data panel 800, the range of confidence panel 900, the profit-and-loss chart 600, the strike price slider panel 1000, the limit panel 700, and the show-hide button 316; and elements of the trading page 300 from bottom left to bottom right include the financial instrument panel 310, the strategy panel 312, the quantity panel 314, and the buy-sell panel 1100.

FIG. 5 shows time slider panel 500 which is, in one implementation, an expiration date slider. In the trading system 200, the user is offered an expiration date slider for selecting the option expiration date. This slider may be at the top right of the page when relevant to the chosen page. The time slider panel 500 dynamically offers the user specific dates for trading, including market standard tenors and additional tenors as defined by the market maker. Furthermore, the user may choose bespoke expiration dates when on the trading page 300 with a long-press of the slider, for example. FIG. 5 also shows a time slider handle 504, time slider label 502, and a time slider range 506.

FIG. 6 illustrates a profit-and-loss chart 600. In one embodiment, for each strategy, the trading page 300 displays a responsive profit-and-loss chart 600 which is a bar chart showing the net profitability of a trade on its horizon date at the levels of the underlying asset price shown on the y-axis 608. The horizon date is determined by the user using the time slider panel 500. For spot trades, the time slider panel 500 is used to determine the amount of historical data that is displayed in a chart, with the most recent bid and ask price displayed as its end point, which may be kept near the center of the page. Thus, for spot trades, the profit and loss chart is displayed for the relevant range of historical data. For option trades, the time slider represents the range of expiration date of the option(s), and the profit-and-loss chart 600 shows net profit and loss of the option strategy at the horizon date, which is the expiration date. The range of profit indicator 604 shows in green color the range(s) of net profit of the strategy on the horizon date, in horizontal bar chart form for various prices of the underlying asset, while the range of loss indicator 606 indicator shows in red color the range(s) of net loss of the strategy, in bar chart form. Other suitable forms may be used however. Labels give numerical support to the profit and loss chart, in the chosen form of price, account currency value, or quote currency value.

The profit-and-loss chart 600 changes dynamically with changes in the live streaming asset price, changes in the strike price(s), changes in limit levels for entering the market, and additionally uses color coding to show the impact of opening and closing limit levels added to any order. For example, the range of profit indicator 604 may be green while the range of loss indicator 606 may be red. For options trades, the profit-and-loss chart 600 changes dynamically as the time slider panel 500 time indicator is changed by the user, and also changes dynamically as the strike price slider panel 1000 is manipulated (as discussed further below).

For spot transactions, the profit-and-loss chart 600 shows the maximum profit at the take profit level, and the maximum loss at the stop loss level. The profit-and-loss chart 600 shows either the trade profit/loss in total amount of the underlying assets quoted (or “term”) currency, in total amount of the account currency, or in price format (e.g., for EUR/USD trade, 0.0023=23 pips). The user may toggle between the views by touching anywhere in the profit-and-loss chart 600.

The profit-and-loss chart 600 and its dynamic nature allow the user to understand the impact of changes in expirations date, strike prices, and strategies on the profitability of a trade. The profit-and-loss chart 600 helps a user understand risk and reward, a fundamental concept that drives options theory and pricing. The dynamic and visual nature of the trading interface, including the bounding of the range of future outcomes for options trades based on the Confidence Intervals, make understanding risk intuitive and interactive, rather than numerical and abstract, and enhances the user experience.

FIG. 7 shows a limit panel 700. For various strategies, the user is offered a slide-out limit panel 700 which is activated but touching the limit panel on the very right side of the trading page 300. The limit panel 700 offers two sliders parallel with the strike price slider 1002. The limit sliders allow the user to define open and close limits for the user's strategy. The limit panel 700 can be closed, and all limit levels canceled, by touching the “X” at the right side of the panel.

The open limit slider 708 allows the user to define the price at which the user is willing to enter or execute a trade. In one implementation, there can be zero or one open limit handle 702 on the open limit slider 708. By default, there is no handle shown, meaning the user is not setting an open limit level. If the user touches anywhere on the open limit slider 708, an open limit handle 702 is automatically added.

If a handle is set on the open limit slider 708 below the current market price of the financial instrument or option strategy, where the user is set to buy the instrument or strategy, the user is defining a buy limit order. The words “buy limit” automatically label the handle the buy limit handle. If the user places or moves the entry limit slider above the current market price of the financial instrument (or the current price changes such that it is below the limit level) then the words “buy stop” automatically replace the label of the handle. Limit and stop orders have different implications in trading and are often difficult for users to understand. The trading system 200 interface makes their definition and application clear and unambiguous. The trading system 200 automatically labels the limit levels, and in the case of spot trades, adds horizontal lines showing the limit levels on the historical trading data chart. Setting the limit below the current market level means the user wishes to enter the trade at a better price. Setting the limit above the current market level means the user wishes to buy at market if the price reaches that level, to “stop” waiting and missing execution in the market.

Furthermore, the slider arc may use colors to make order entry clear. The color coding is responsive to the user's actions. The slider arc is colored red in the section for stop limit orders, where a user is entering a price to enter the market at a worse level, setting a limit of his tolerance for staying out of the market. The slider arc is colored green in the area for limit orders, where a user is trying to enter a trade at a better level than the current market price. There is a small range of the slider arc colored grey, a range where a trader may not place any limit order. This is a range that is close to the prevailing market level, and brokers set a “minimum distance” from the prevailing market price, defining a range where the broker is not willing to accept orders. This concept is difficult to explain a priori, and is often difficult to understand; traditional order entry screens of most trading platforms, which are based on numeric entry of limit levels, have no way to prevent entry of unacceptable order levels a priori. They can typically only reject orders after the user attempts to submit such orders, and respond with an explanation of why the order is not acceptable. However, this is cumbersome, hard to understand, and slows down the trader. The trading page 300 chart-based order entry offers clarity; order levels impact the profit and loss chart directly, including updating the profit and loss at the limit levels, offering clarity to the trader.

The close limit slider 710 has no handles by default, and, in one implementation, can have zero, one, or two handles. If the user is setting up a buy strategy, and the user touches the close limit slider 710 at a price above the current market price, or above the open limit price if one has been set, the user is entering a sell limit price, also known as a take profit order. The user wishes to sell at this higher price if the associated open limit order had been filled.

The user can also place a close limit handle 706 below the current market price, or below the open limit level if such a limit has been set. If the order is a buy strategy, placing the close limit below the open price is a sell stop limit order, also known as a stop loss order. A stop limit order becomes a market order, executed at market price, once the stop limit level is the best market price available for execution. Similarly, in a sell strategy, a close limit level set above the market price or open limit price if set, is a stop loss order, as it limits the loss incurred from the position if the market trades higher to or through that level.

The trading system 200 automatically determines and labels a close limit order as a take profit or stop loss order, depending on its placement relative to the market price or open limit level if set. Such labeling is live and interacts with both the live streaming market price for the chosen strategy and any other limit levels set. This prevents a user from defining invalid limit levels and assists in defining strategies, visualizing risk, and best practices for trading. In one implementation, this interaction includes allowing a maximum of one open limit level, one close take profit level, and one close stop loss level. Any combination of one, two, or three choices can be set.

Additionally, the coloring of the close limit slider 710 is dynamic, showing areas of profit and loss relative to the entry price, whether the entry is at the market price or an entry limit level. Thus, the interface makes understanding and setting the close limit level easy.

In the case of spot orders, the close limit slider 710 is accompanied by horizontal lines into the chart history and profit/Loss diagram, labeling the profit or loss associated with the close limit order(s) intuitively, and displaying numerically the profit in the format chosen by the user.

In one implementation, a user may place two close limit orders, one being a take profit order, and one being a stop loss order. The trading system 200 will not allow a user to place two close limit orders, nor will it allow the user to place two take profit orders. In the example of a buy strategy, if the user sets one take profit order, and one stop limit order, and then slides or drags the handle for the stop loss order higher, such that it crosses the open limit price or market ask price, it automatically becomes a take profit order, in conflict with the take profit order that was already set. In this implementation, trading system 200 automatically removes the earlier take profit order, giving the visual cue to the user that the new order level has replaced the previous setting. Similarly, if both take profit and stop loss orders were set, and the user drags the take profit handle down along the slider such that it becomes a stop loss order, the previously set stop loss order will automatically be removed from the screen. In the same manner, if a take profit order is set, and the user touches the slider, the user will toggle the take profit order off, instead of creating a new take profit order. This interactivity is beneficial for the user's understanding.

There is a range of prices within which the user is prevented from setting any limit levels. This range is known as the “minimum distance” above and below the current market price. A buy stop order cannot be set below the minimum distance above the current market offer price. In a sell strategy, similarly, a sell stop order cannot be set higher than the minimum distance below the current market bid price.

Setting these rules in words is cumbersome, and conventional platforms can typically explain these rules with text, F.A.Q.s, or terms and conditions documents. Users entering orders that violate these rules only get feedback when clicking to place the order, and such feedback may prevent them from timing the execution of their trades. The trading system 200, the range where limits may not be set is seen along the limit slider arcs in grey color, between the green section of the limit section and red of the stop order section of the entry order slider, and between the red of the stop loss section and green of the take profit section of the close order slider. If the user lifts his finger from the handle while it is in this grey section of the slider, no limit will be set, and the handle will toggle off. In one implementation, this assists the user in getting that they see, as no invalid orders can be set.

FIG. 8 shows a historical data panel 800. The trading page 300 shows historical data, for example, on the left half of the screen, and a representation of the future predicted range of the market on the right side, complete with the profit-and-loss chart 600 which shows the performance of a proposed trade over the predicted range (see the range of confidence panel 900 described further below) as well as any other range chosen by the user, as the user can pinch/zoom with his fingers and scroll up/down to see any desired range of possible outcomes. The integration of the past historical data, future likely potential market range, and profit/loss chart provides the ability to both explain and assist in the structuring of the proposed trade to match the user's risk appetite and market view in a consistent frame

This historical data panel 800 includes a historical price range 802, a historical timeline 804 a data format selector 806, a bid price 812 and a live streaming asset price indicator 808, and ask price 810.

FIG. 9 shows the range of confidence panel 900. For options strategies, the trading page 300 automatically presents a set of arcs, representing ranges of confidence for potential future prices of the given asset for the tenor of the option, using implied volatility of the option with 50% delta for that tenor. This presents the user with a picture of the potential outcomes of the user's proposed trade, to give a consistent frame for the risk the user is considering. A confidence interval gives a range of potential future values for the asset; to have a higher confidence that the future price will fall within a range, it needs to define a broader range. Mathematically, 68% of potential future values are expected to be within the range defined by +/−one standard deviation of returns, as shown by the inner parabolic indicator 902; 95% of potential future values are expected to be within the range defined by +/−two standard deviations of returns, as shown by the white parabolic indicator 904; and 99.7% of potential future values are expected to be within the range defined by +/−three standard deviations of returns, as shown by the outer parabolic indicator 906.

The 95% confidence interval is outlined with a white line for emphasis, while the other ranges are indicated with grey shading in the background. Animation is used to clearly show that the range of confidence is related to the horizon date/option expiration tenor. As the user slides the time slider handle 504 out to a longer tenor, the range of confidence expands (i.e., more time means more variance, which means greater distribution of future prices) on the same Y-axis, and then the Y-axis shrinks so that the 95% confidence interval can be displayed in full on the page, giving the user a clear picture of the impact of a longer date on the range. The converse action is seen when the user chooses a shorter tenor. The historical price chart is automatically updated once the user lifts their finger from the screen, thus choosing the new tenor the user wishes to investigate. The historical data period automatically matches the tenor, such that the screen shows a historical chart and a future potential outcomes chart in equal measure. Two months of historical data are shown alongside a two-month option. The user may then use, for example, “pinch and zoom” to adjust the amount of historical data shown.

Also shown on this figure are the strike price indicator 602, the live streaming asset price 808. The bid price indicator 812 and the ask price indicator 810.

FIG. 10 shows the strike price slider panel 1000, which may be, for example, on the right side of the trading page 300. Users use the strike price slider panel 1000 to explore the pricing of financial instruments, including options strategies. In one implementation, the strike price slider 1002 is only shown for options strategies; where a user is only pricing and trading the underlying instrument (e.g., “spot” and “forward” for currency trading where offered) no strike price slider 1002 is displayed. The strike price slider 1002 offers a dynamic range of strike prices from the equivalent of a 5-delta “put” up to the equivalent of a 5-delta “call.” Delta values are displayed along the slider, further enhancing the user's understanding of the range of strikes available. The range of strikes can be seen on the Y-axis of the page, on the left side of the screen.

In one implementation, the strike price slider 1002 has from one to four strike price handles 1004 or more, where each strike price slider handle 1004 allows the user to choose the strike price for a component of the option strategy. A call option strategy has one handle. A “strangle” option strategy has two handles—one call, and one put. Furthermore, the handles will be dynamically labeled to indicate that the strategy requires buying or selling the option, and whether the handle refers to a call, put, or call and put, in the case of several specific strategies.

As the user changes the strike price(s) via the strike price slider handle 1004, the trading system 200 continuously recalculates the total cost of executing the strategy, and displays this cost in the buy and sell buttons for buying and selling the strategy, respectively.

FIG. 11 shows the buy-sell panel 1100. The buy-sell panel 1100 is in the bottom right corner of the trading page 300. The buy panel 1102 includes a pay amount indicator to quickly and easily verify what amount would be paid if a purchase were transacted for the financial instrument, strategy, and quantity specified. The sell panel 1104 includes a receive amount indicator to enable the user to quickly and easily verify what amount would be received if a sale were transacted for the financial instrument, strategy, and quantity specified. In some strategies with multiple components, the buy panel may show that the trader will receive net premium, and the sell panel may indicate that the trader must pay net premium.

In some embodiments shading, coloring, or highlighting are used to show that either the sell panel 1104 or the buy panel 1102 is active. For example, as shown in FIG. 3, the buy panel 1102 is active, and the sell panel 1104 is inactive. This means that the pricing shown on the screen relates to buying the strategy, which may comprise buying one or two options, and selling zero, one, or two options.

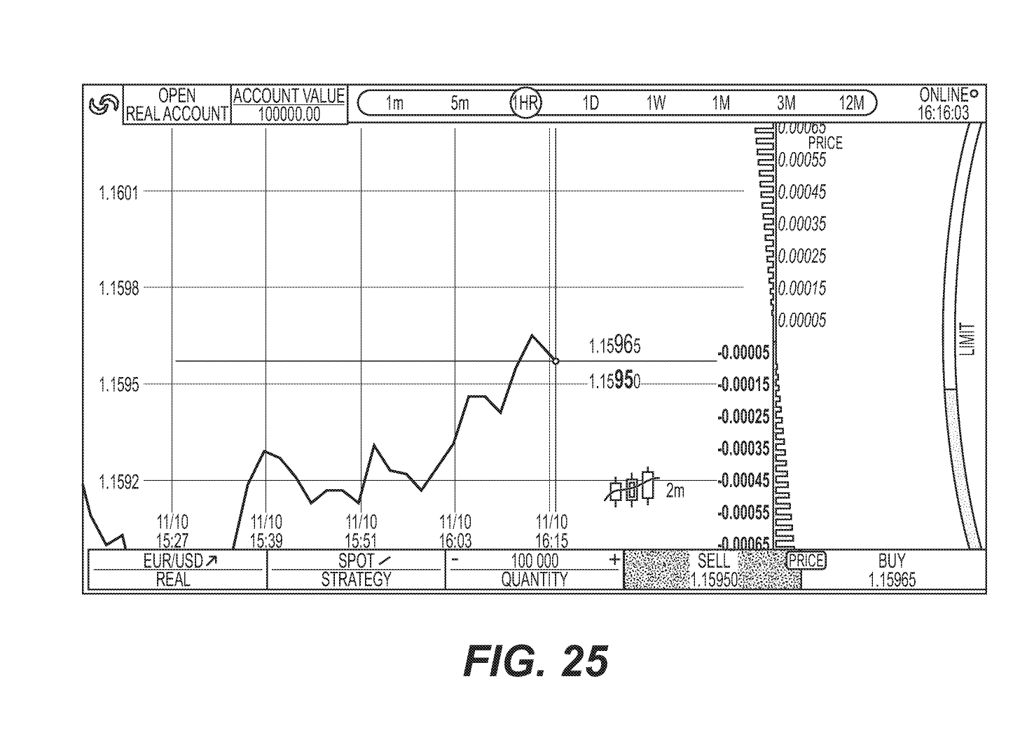

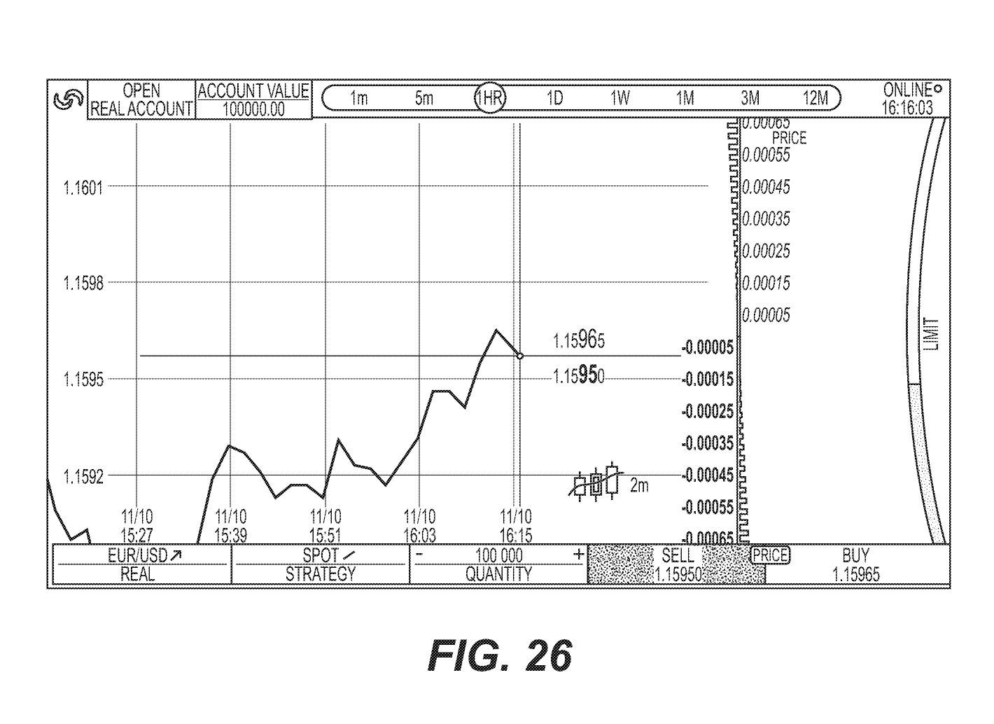

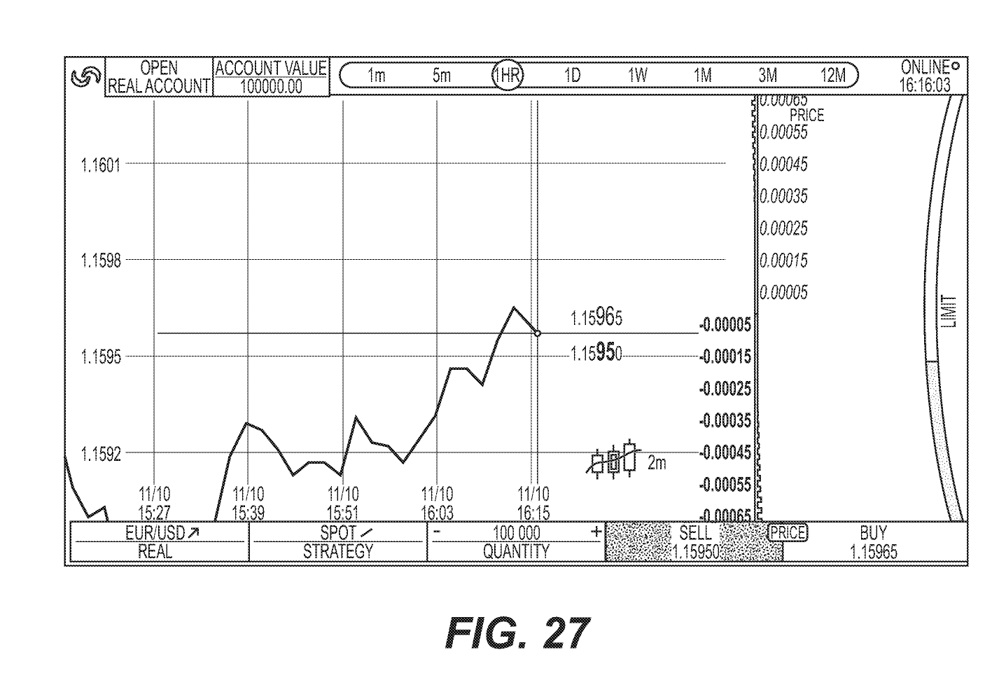

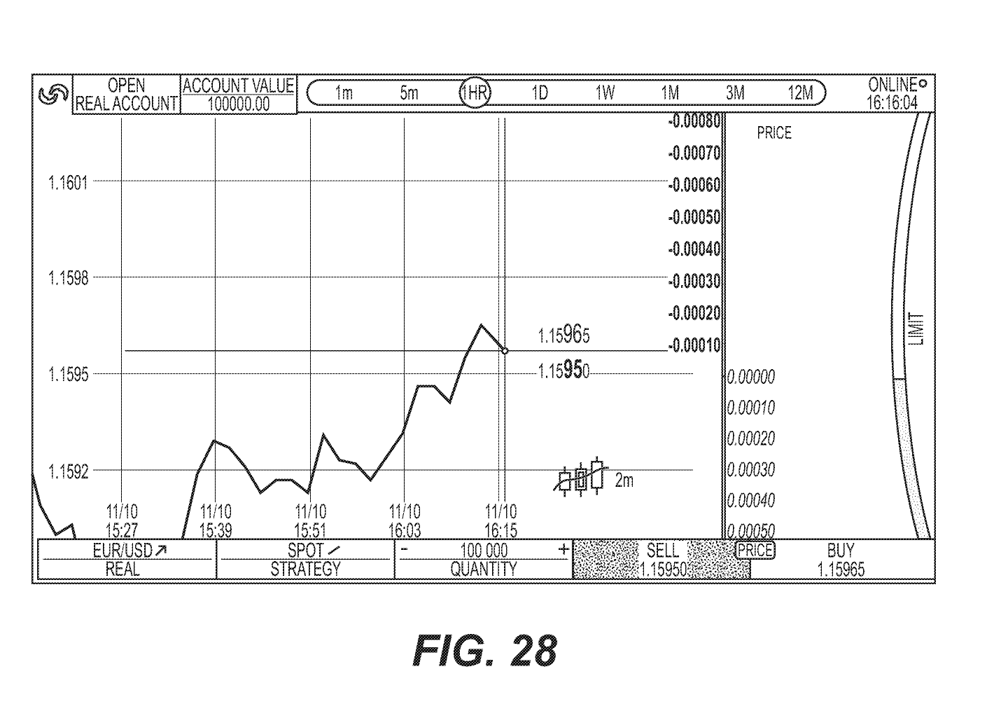

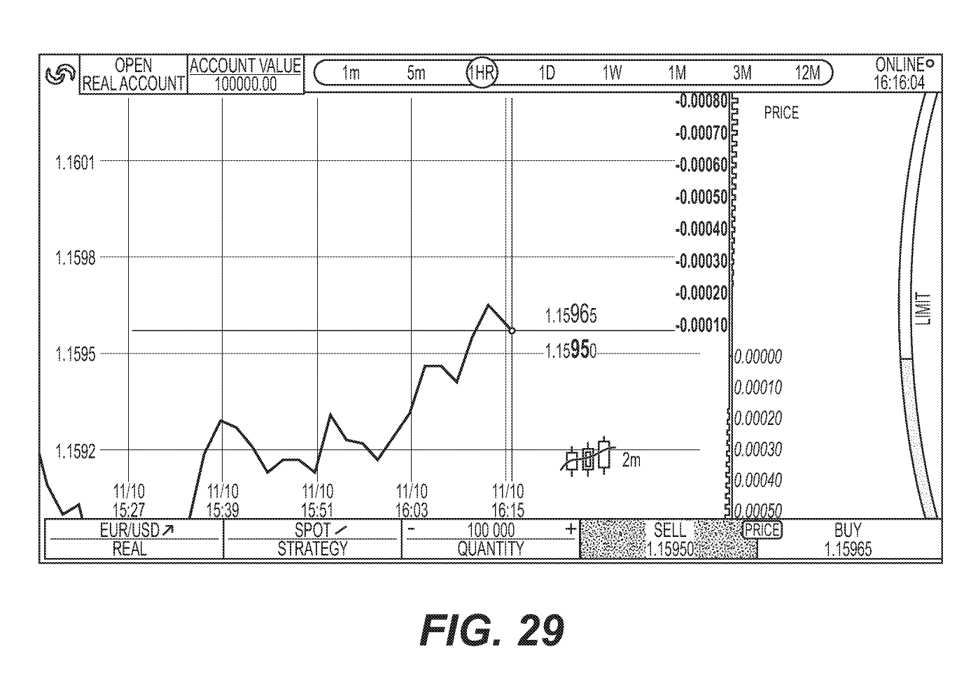

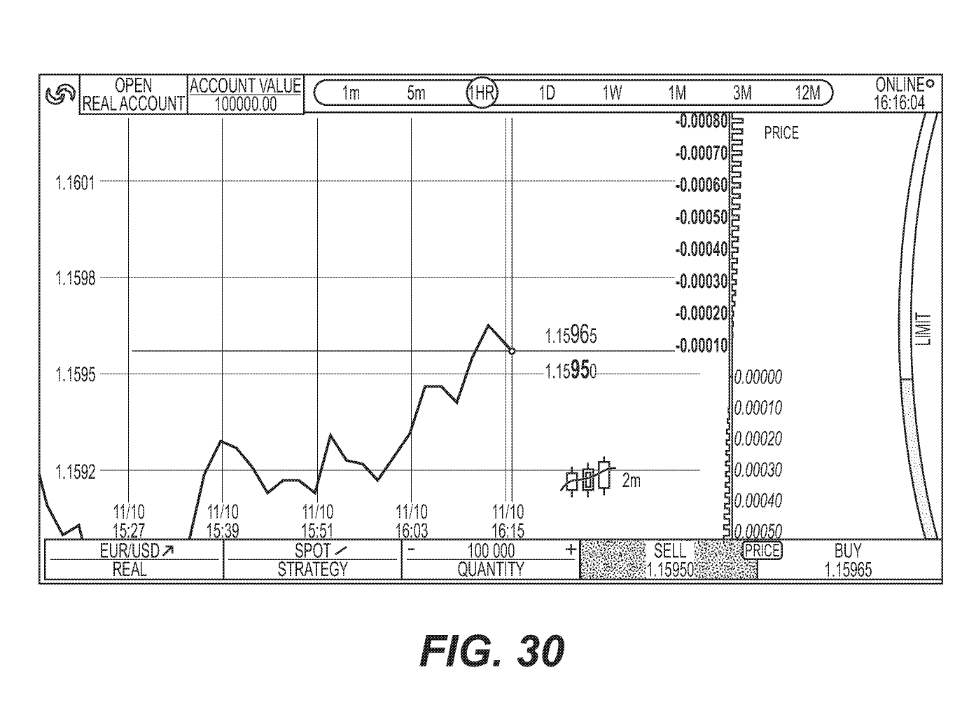

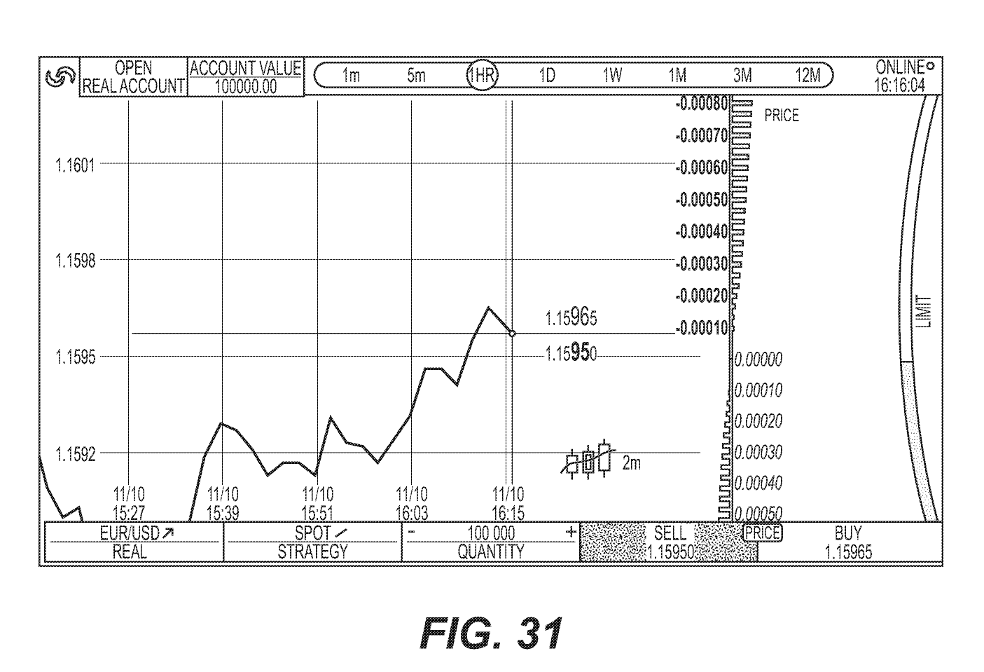

Tapping the sell panel 1104 when it is inactive causes it to become active and deactivates the buy-sell panel 1100. Activating the sell panel 1104 thus also updates the profit-and-loss chart 600 (see FIG. 6 and FIG. 23 through FIG. 32) and updates the prices of the options being traded. Tapping the sell panel 1104 when it is already active causes a transaction execution page to appear, enabling the user to review his proposed trade once more before executing the specified transaction.

In like manner, tapping the buy panel 1102 when it is inactive causes the buy panel 1102 to become active and deactivates the sell panel 1104. Activating the buy panel 1102 thus also updates the profit-and-loss chart 600 (see FIG. 6 and FIGS. 23-32) and updates the prices of the options being traded. Tapping the buy panel 1102 when it is active causes the transaction execution page to appear, enabling the user to review their proposed trade once more before execution.

FIG. 12 shows a strategy selector page 1200. The strategy selector page 1200 presents the user with a matrix of different options strategies for pricing and execution, including call, put, strangle, “straddle,” “condor,” “butterfly,” “seagull,” and other common strategies. A long-press on any of these strategies brings a popup with an explanation of the strategy, so a new trader can learn and understand the components, risk profile, and application of the strategy. Additionally, the trading system 200 allows users to trade options with a delta hedge (not shown), extending its relevance to advanced traders wishing to trade spot and option risk independently.

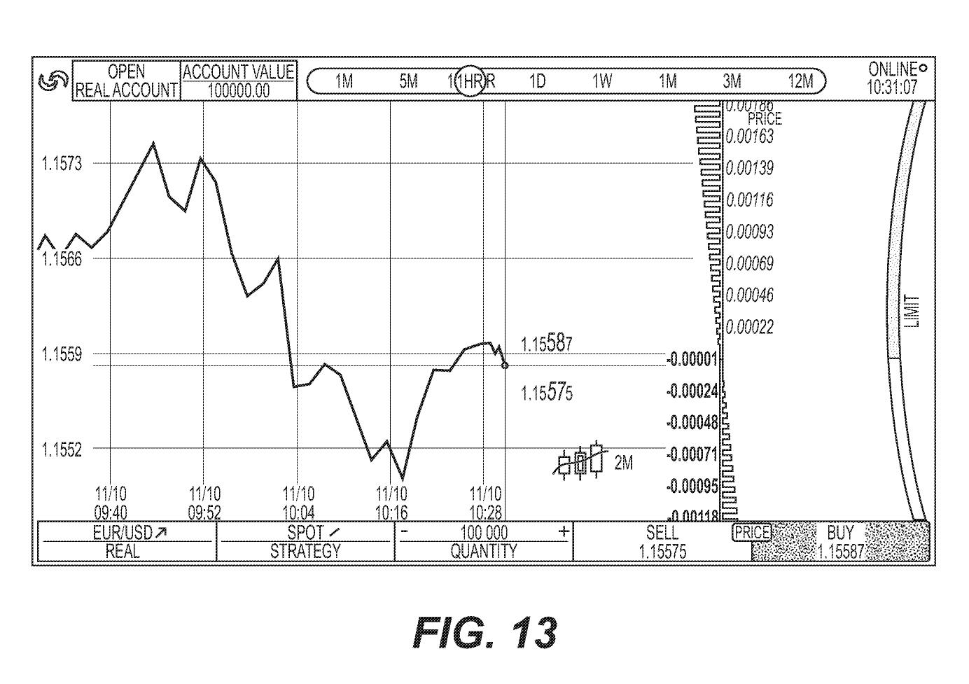

FIGS. 13-17 show how the trading page 300 responds to a change from one trading strategy (spot) to another (a call option for one week expiration). In particular, the time slider changes from a tool to choose the period of historical data to a tool to choose the expiration date and historical data. The range of the x-axis of the historical data panel 800 updates quickly or instantly, while the range of the y-axis of the historical data panel 800 updates smoothly after the user changes from one trading strategy to another.

FIG. 13 shows the trading page 300 for trading spot, the underlying asset. The current time is 10:31:07. The time slider panel 500 shows a range from 1 minute (1 m) to 12 months (12 M). The time slider handle 504 is set to 1 hour (1 HR), and thus one hour of historical data has been retrieved and charted, with the current live market price kept near the center of the screen. In one implementation, the Y-axis has automatically adjusted to show all the historical data retrieved. The profit-and-loss chart 600 shows a potential profits and losses corresponding to this Y-axis. That is, the scale of the profit-and-loss chart 600 reflects the range of prices seen for the past hour (the time specified in the time slider panel 500) the price of the financial instrument in question (here, EUR/USD as shown by the financial instrument panel 310) in the past hour has traded in a range from −0.00118 to +0.00186 of its live streaming asset price 808.

The range of the y-axis of the historical data panel 800 is approximately 0.0021, from 1.1552 to 1.1573. The range of the x-axis of the historical data panel 800 is approximately one hour, from October 11 (11/10) at 09:40 to the present time of 10:31:07 on the same date.

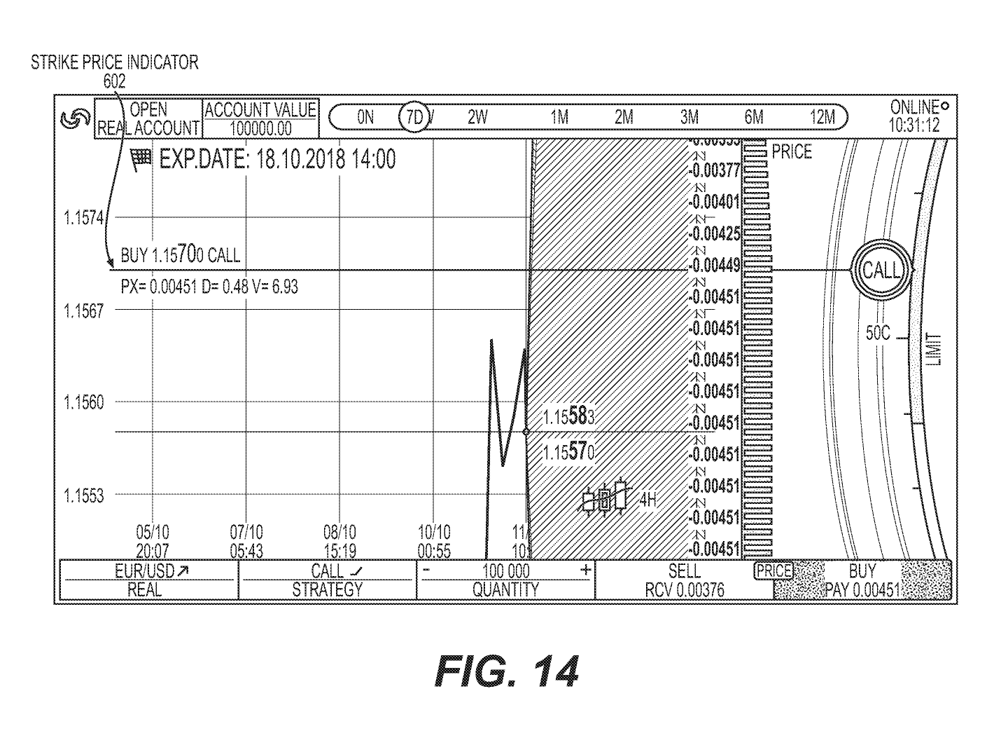

FIG. 14 shows the trading page 300 just after the user has changed from the spot trading strategy of FIG. 13 to the call strategy. This is the first frame of a short animation that transitions the trading screen to the new chosen strategy, helping the user understand what is being presented. The current time is 10:31:12. The time slider panel 500 has changed to show a range from the shortest option expiration (ON=Overnight=1 day option) to 12 months (12 M), which corresponds to the range of option expiration dates offered for this asset by the broker. The time slider handle 504 is set to 7 days (7 D), which corresponds to a call option expiration date 7 days in the future. The expiration date indicator 318 confirms the call option's expiration date and time. The strike price slider handle 1004 is green, indicating a buy, and shows the word call, indicating a call option. The strike price indicator 1602 confirms the price to buy the call at 1.157000, PX of 0.00451, D=0.48, and V=6.93. (D is the Delta of the option, V is the implied volatility, which is a measure of the option price). Notice that the range of confidence arc (confidence interval), the white arc, has been introduced to the page (it is not used on the Spot trading screen) and it is barely visible on the page—it is reaching outside the page to a much broader range of future potential prices than the current Y-axis range.

Initially, the range of the y-axis of the historical data panel 800 remains approximately the same as it was for the spot trading shown in FIG. 13, at 0.0021, from 1.1553 to 1.1574. But the range of the x-axis of the historical data panel 800 is now approximately seven days, from October 5 (05/10) at 20:07 to the present time of October 11 (11/10) at 10:31:13.

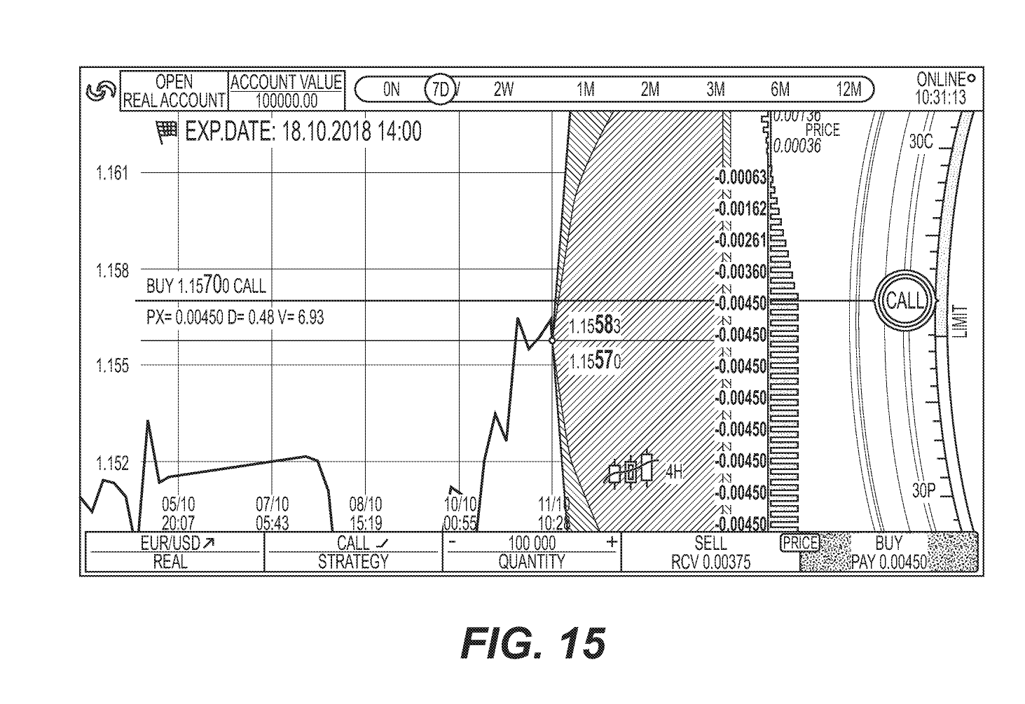

FIG. 15 shows the trading page 300 as it appears just after the view shown in FIG. 14. The current time is 10:31:13. The time slider panel 500 remains at 7 days (7 D). The range of the y-axis of the historical data panel 800 has increased to 0.009, ranging from 1.152 to 1.161. This can be observed as an overall flattening of the historical price trend line 814.

The smooth updating of the y-axis can also be observed in the range of confidence panel 900, the profit-and-loss chart 600, and the strike price slider panel 1000. For example from FIG. 14 to FIG. 15, the second standard deviation curve 904 becomes more concave, the range of the profit-and-loss chart 600 expands to include profits up to 0.00136, and the range of the strike price slider panel 1000 expands to show deltas from 30P to 30C.

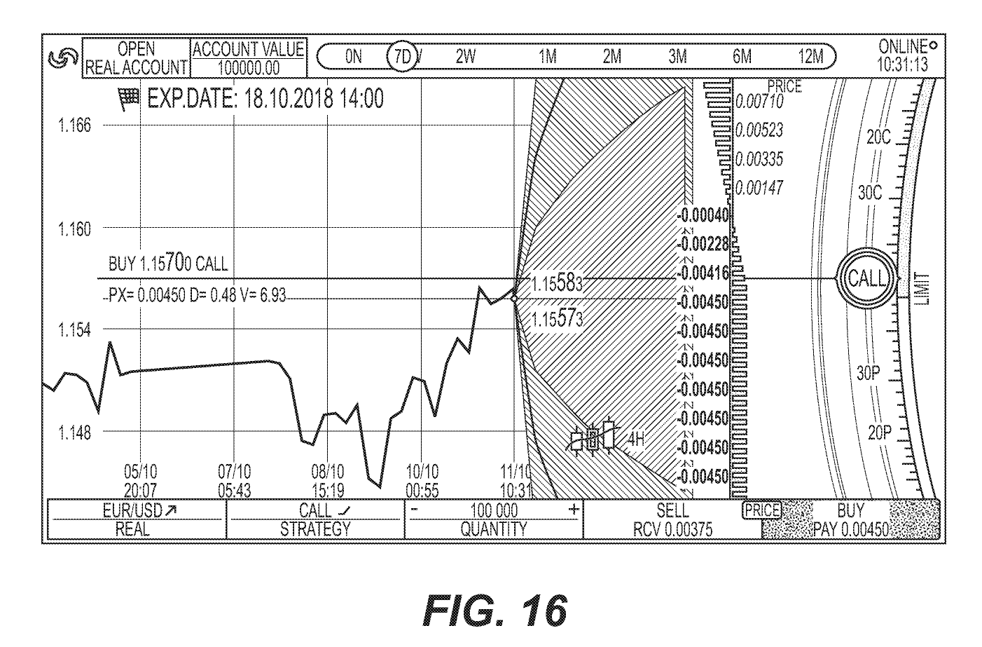

FIG. 16 shows the trading page 300 as it appears less than one second after the view shown in FIG. 15. The current time is still 10:31:13. The time slider panel 500 remains at 7 days (7 D). The range of the y-axis of the historical data panel 800 has increased to 0.018, ranging from 1.148 to 1.166. The smooth updating of the y-axis from FIG. 15 to FIG. 16 can be observed as further flattening of the historical price trend line 814, the second standard deviation curve 904 becoming even more concave, the range of the profit and loss chart further expanding, and the range of the strike price slider panel 1000 expanding to show deltas from 20P to 20C.

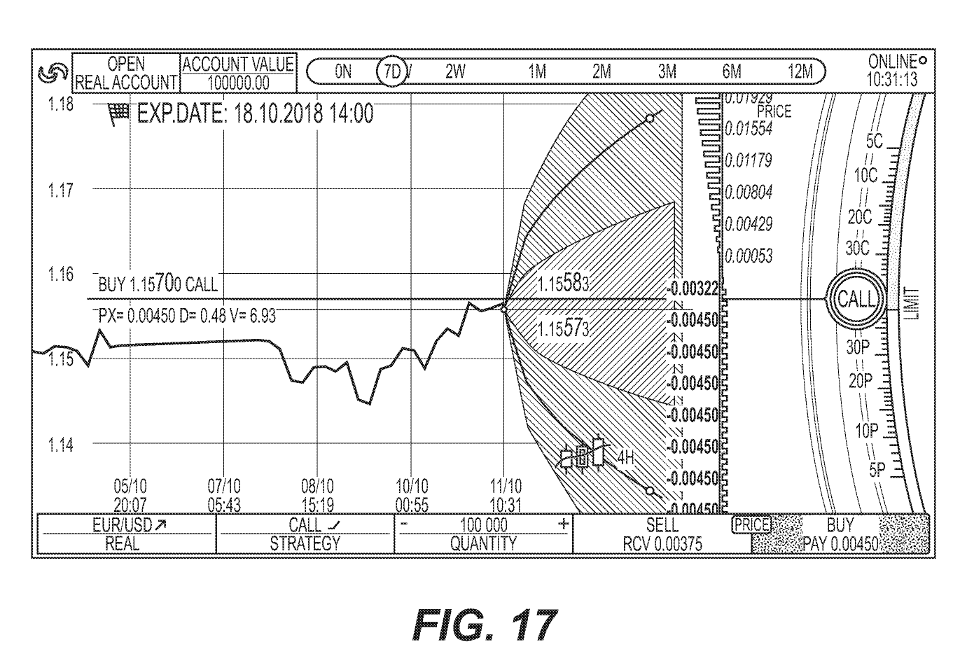

FIG. 17 shows the trading page 300 as it appears less than one second after the view shown in FIG. 16. The current time is still 10:31:13. The time slider panel 500 remains at 7 days (7 D). The range of the y-axis of the historical data panel 800 has increased to 0.04, ranging from 1.14 to 1.18. The smooth updating of the y-axis from FIG. 16 to FIG. 17 can be observed as further flattening of the historical price trend line 814, the second standard deviation curve 904 becoming even more concave, the range of the profit and loss chart further expanding, and the range of the strike price slider panel 1000 expanding to show deltas from 5P to 5C.

FIGS. 17-22 show how the trading page 300 responds to a movement of the time slider handle 504. In particular, the range of the x-axis updates quickly, but the range of the y-axis updates more slowly and smoothly after the user moves the time slider handle 504 from one date horizon to another.

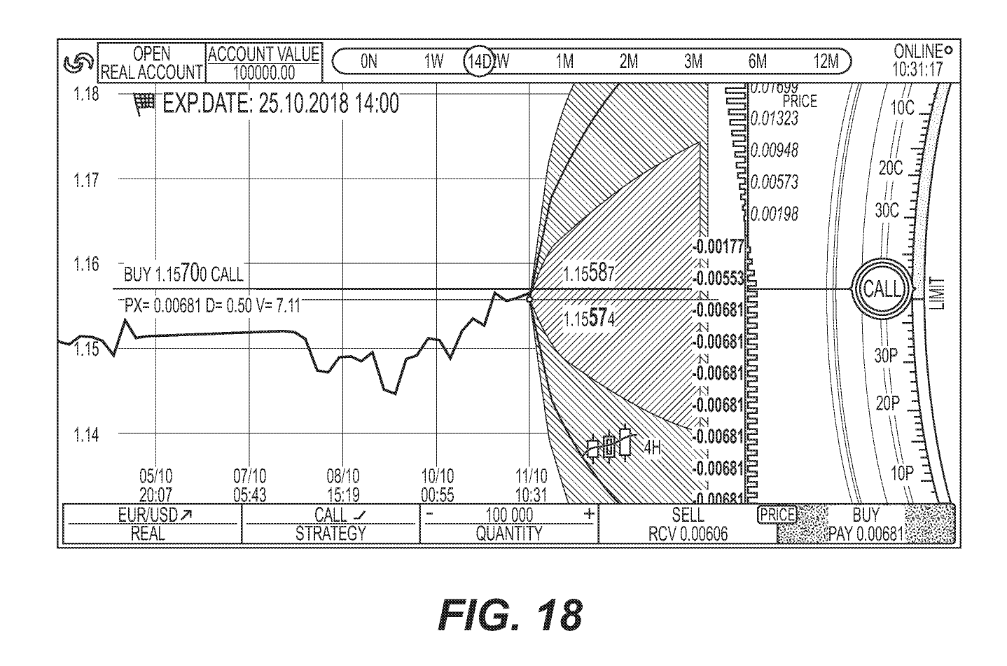

FIG. 18 shows the trading page 300 several seconds after the view shown in FIG. 17, when the user has moved the time slider handle 504 from 7 days (7 D) to 14 days (14 D). The current time is 10:31:17. The ranges of the x-axis and y-axis of the historical data panel 800 remain approximately the same as in FIG. 17, but the y-axis ranges of the range of confidence panel 900, the profit-and-loss chart 600, and the strike price slider panel 1000 have changed. Specifically, the second standard deviation curve 904 has become less concave, the range of the profit-and-loss chart 600 is reduced, and the range of the strike price slider panel 1000 is reduced to show deltas from 10P to 10C.

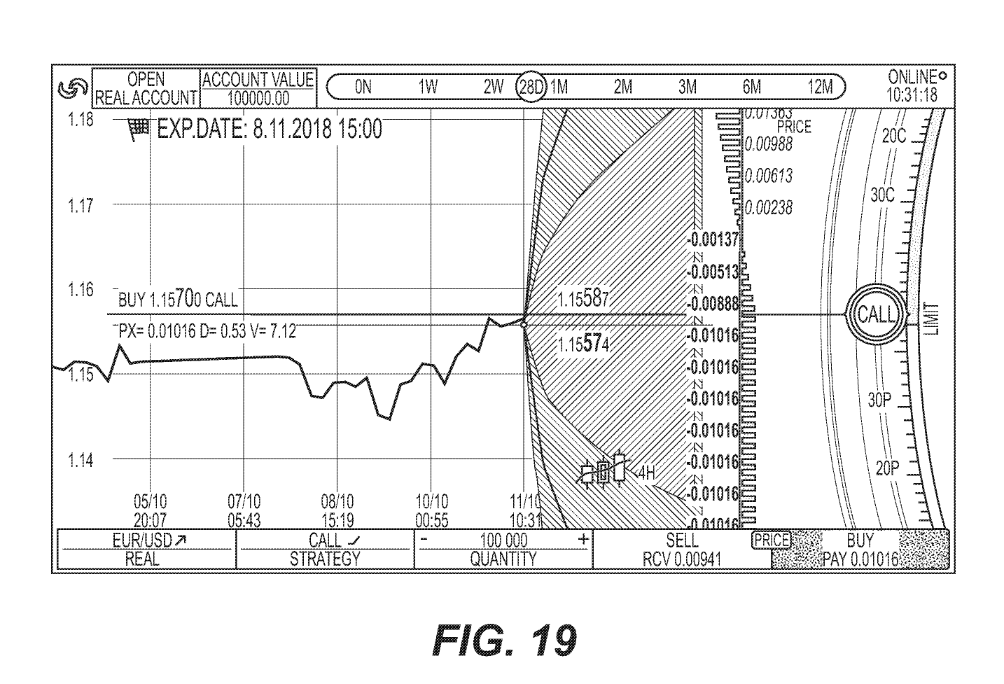

FIG. 19 shows the trading page 300 just after the view shown in FIG. 18, when the user has moved the time slider handle 504 to 28 days (28 D). The current time is 10:31:18. The ranges of the x-axis and y-axis of the historical data panel 800 remain approximately the same as in FIG. 17 and FIG. 18, but the y-axis ranges of the range of confidence panel 900, the profit-and-loss chart 600, and the strike price slider panel 1000 have changed. Specifically, the second standard deviation curve 904 has become even less concave, the range of the profit-and-loss chart 600 is reduced, and the range of the strike price slider panel 1000 is reduced to show deltas from 20P to 20C.

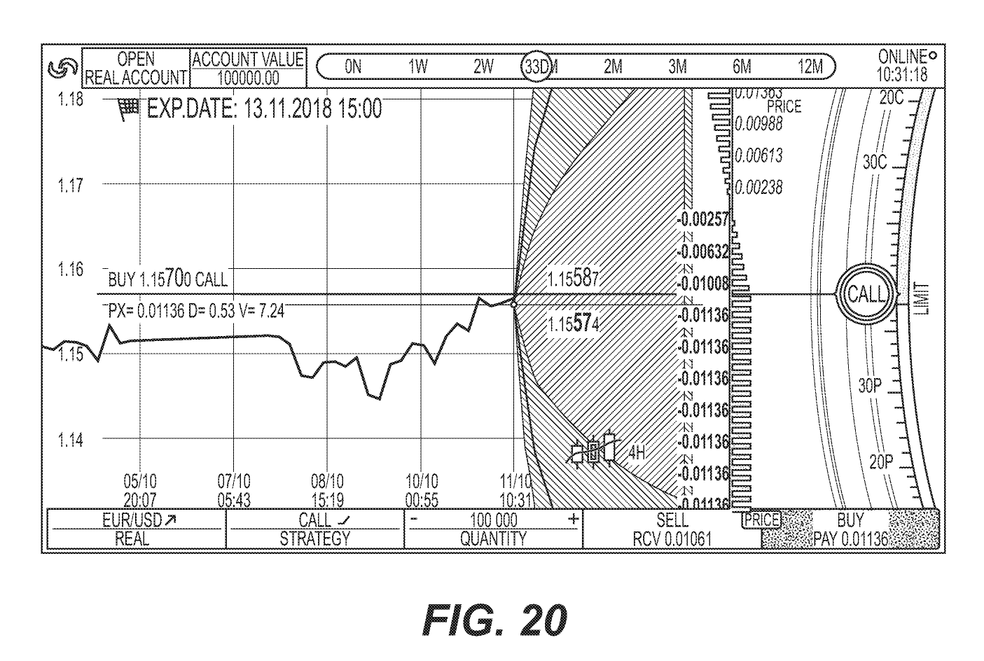

FIG. 20 shows the trading page 300 less than a second after the view shown in FIG. 19, when the user has moved the time slider handle 504 to 33 days (33 D). The current time is 10:31:18. The ranges of the x-axis and y-axis of the historical data panel 800 remain approximately the same as in FIG. 17, FIG. 18, and FIG. 19, but the y-axis ranges of the range of confidence panel 900, the profit-and-loss chart 600, and the strike price slider panel 1000 have changed. Specifically, the second standard deviation curve 904 has become even less concave, the range of the profit-and-loss chart 600 is reduced, and the range of the strike price slider panel 1000 is reduced.

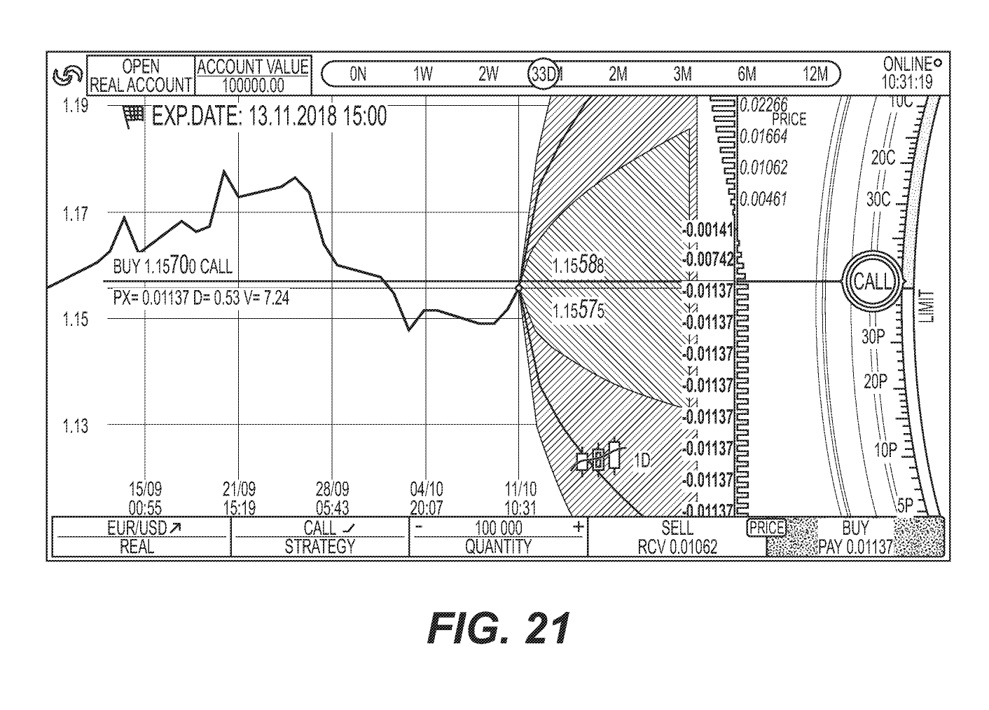

FIG. 21 shows the trading page 300 just after the view shown in FIG. 20, when the time slider handle 504 has been at rest at 33 days (33 D) for approximately one second. The current time is 10:31:19. Changes from the view shown in FIG. 20 are apparent in the x- and y-axes throughout the trading page 300. The range of the x-axis of the historical data panel 800 is expanded to 26 days, from September 15 (15/09) at 00:55 to the present time of October 11 (11/10) at 10:31:19. The range of the y-axis of the historical data panel 800 is also expanded to 0.06, from 1.13 to 1.19. The second standard deviation curve 904 is more concave, the range of the profit-and-loss chart 600 is expanded, and the range of the strike price slider is expanded to show deltas from 5P to 10C.

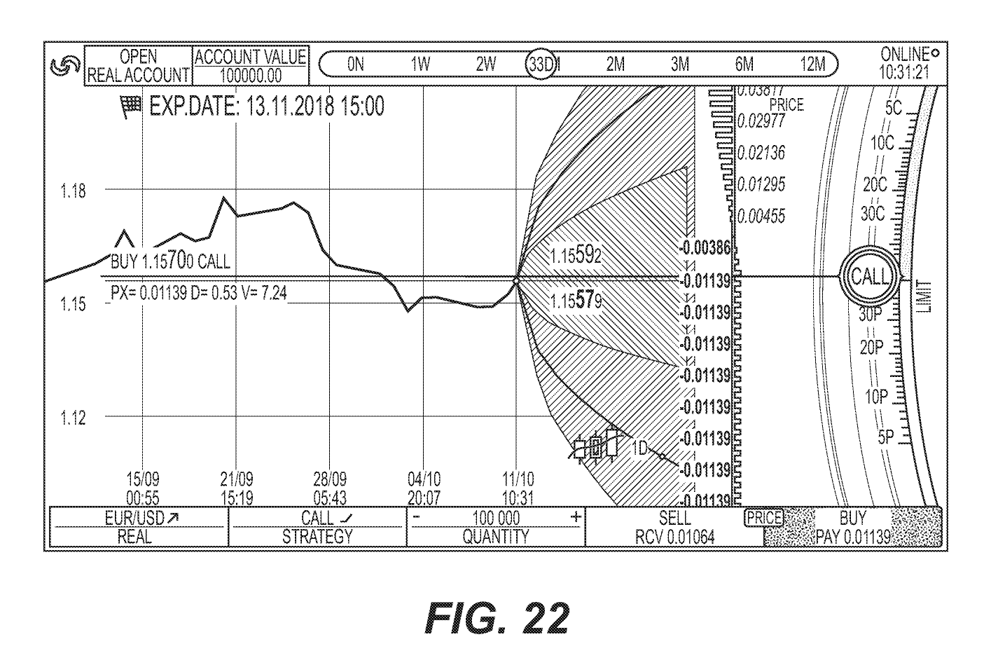

FIG. 22 shows the trading page 300 just after the view shown in FIG. 21, when the time slider handle 504 has been at rest at 33 days (33 D) for approximately three seconds. The current time is 10:31:21. The range of the x-axis of the historical data panel 800 remains approximately the same, but other changes from the view shown in FIG. 21 are apparent. The second standard deviation curve 904 is even more concave, the range of the profit-and-loss chart 600 is expanded, and the range of the strike price slider is expanded to show deltas from 5P to 5C. The animation is now complete, and the user has seen how the ranges have updated to reflect the new horizon date and expiration date. From this point, the screen updates according to the live streaming market prices.

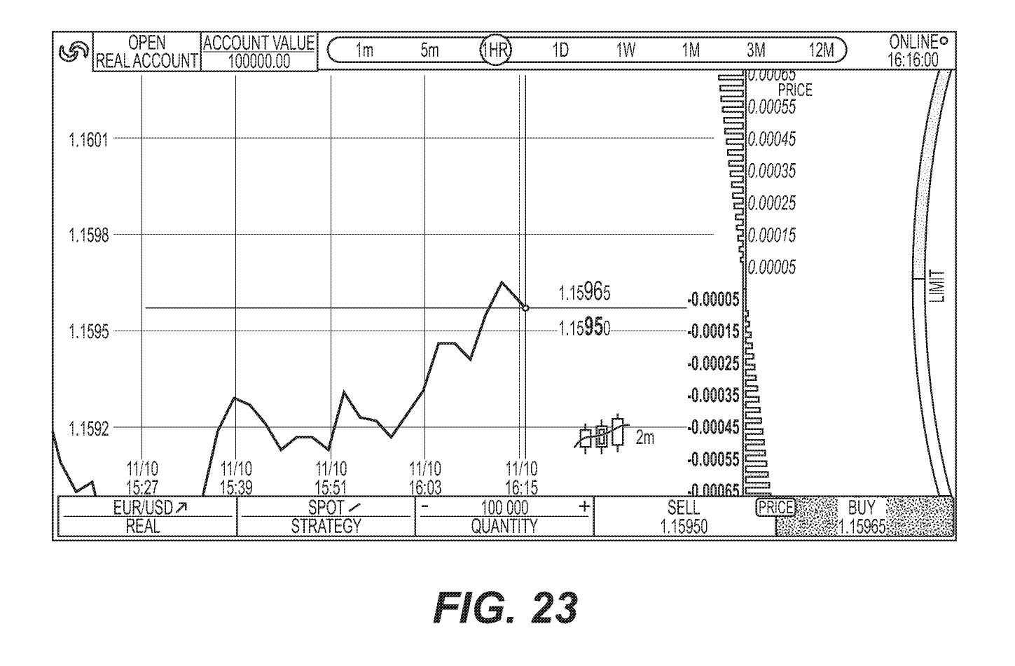

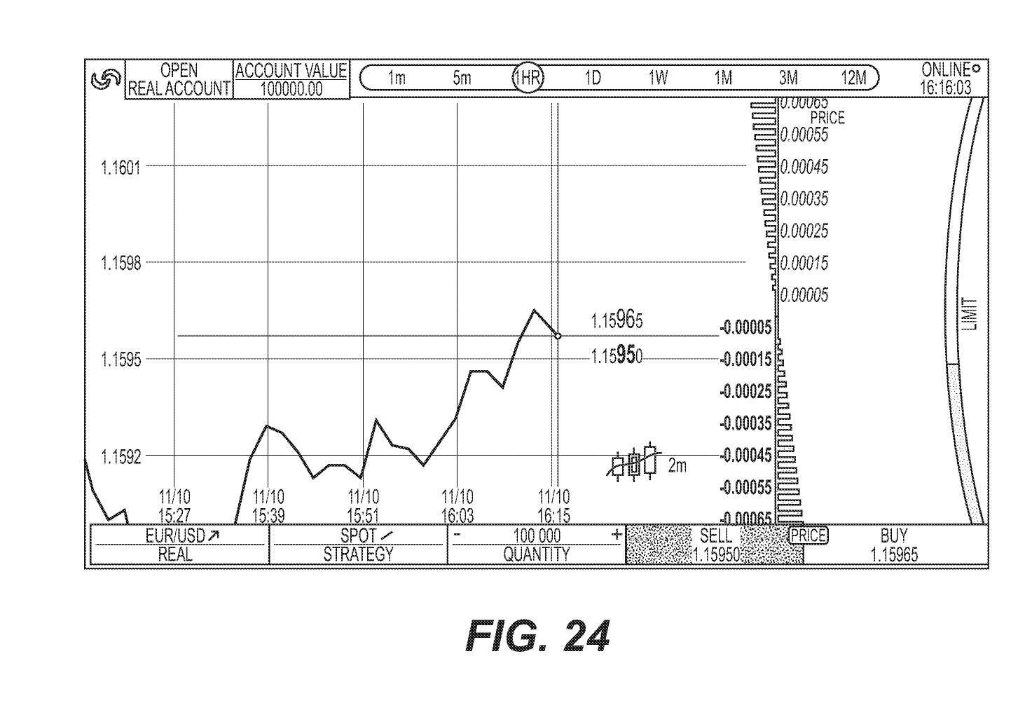

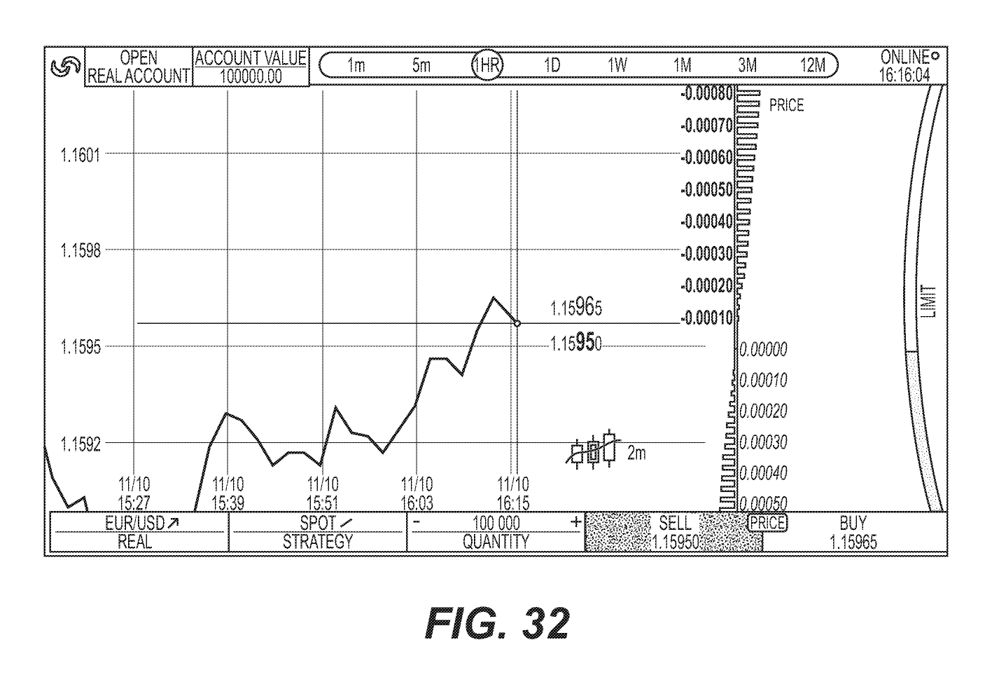

FIGS. 23-32 illustrate how the profit-and-loss chart 600 updates when the sell panel 1104 is activated and the buy panel 1102 is deactivated. The Figures represent an animation of how the profit-and-loss chart 600 changes in response to activation of the buy panel 1102 from the sell panel 1104. As shown, FIG. 23 shows that the range of profit indicator 604 is green (top part of the profit-and-loss chart 600) when buy panel 1102 is activated, and the range of loss indicator 606 (bottom part) is red. After the button is pressed, FIG. 32 shows that the range of loss indicator 606 (bottom part) is now green, and the range of profit indicator 604 (top part) is now red. The FIG. 24 to FIG. 32 show stages of the transformation in between. The animation of the change may help the user understand how aspects are changing as the users changes the inputs.

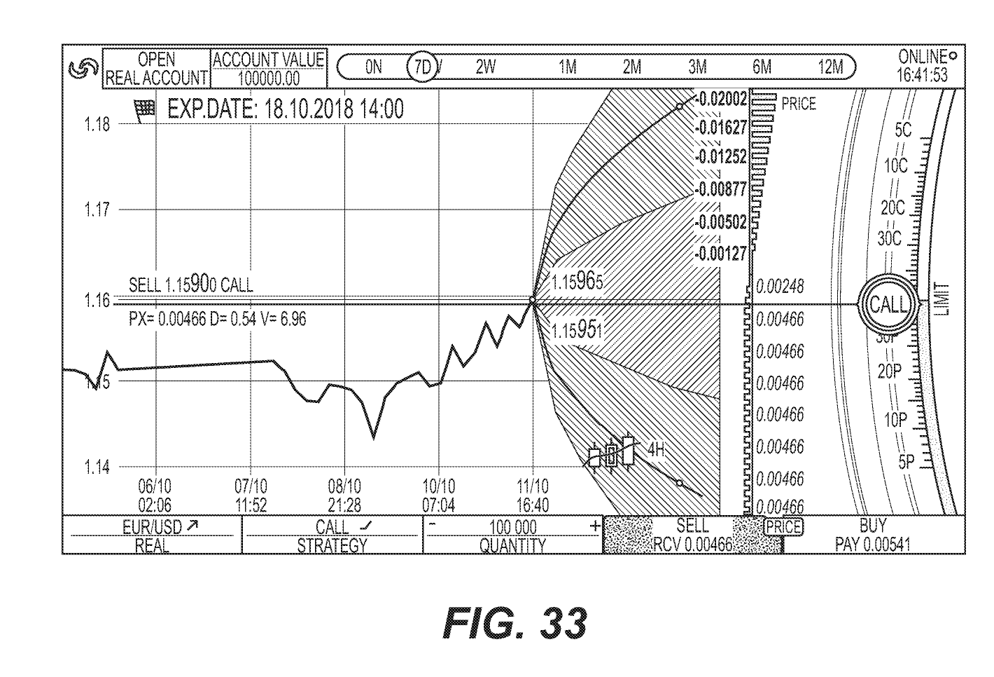

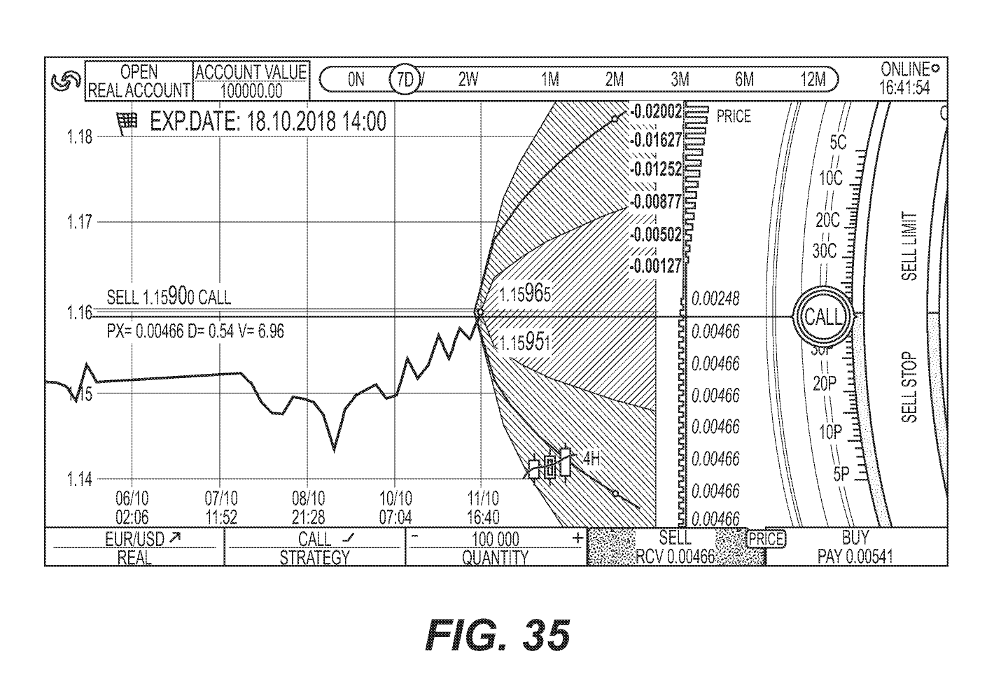

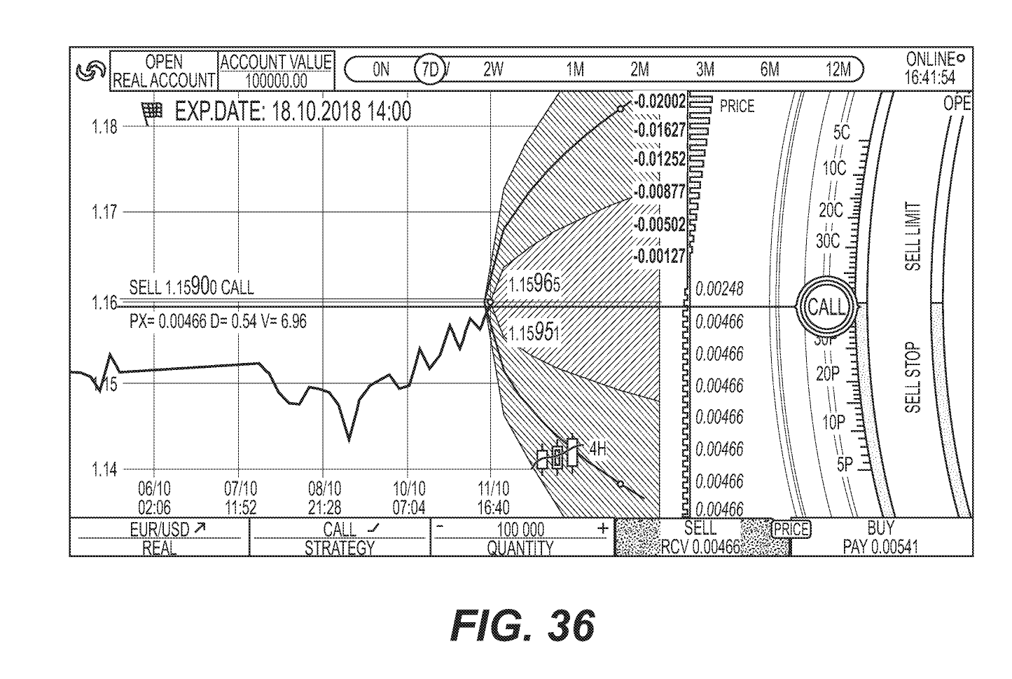

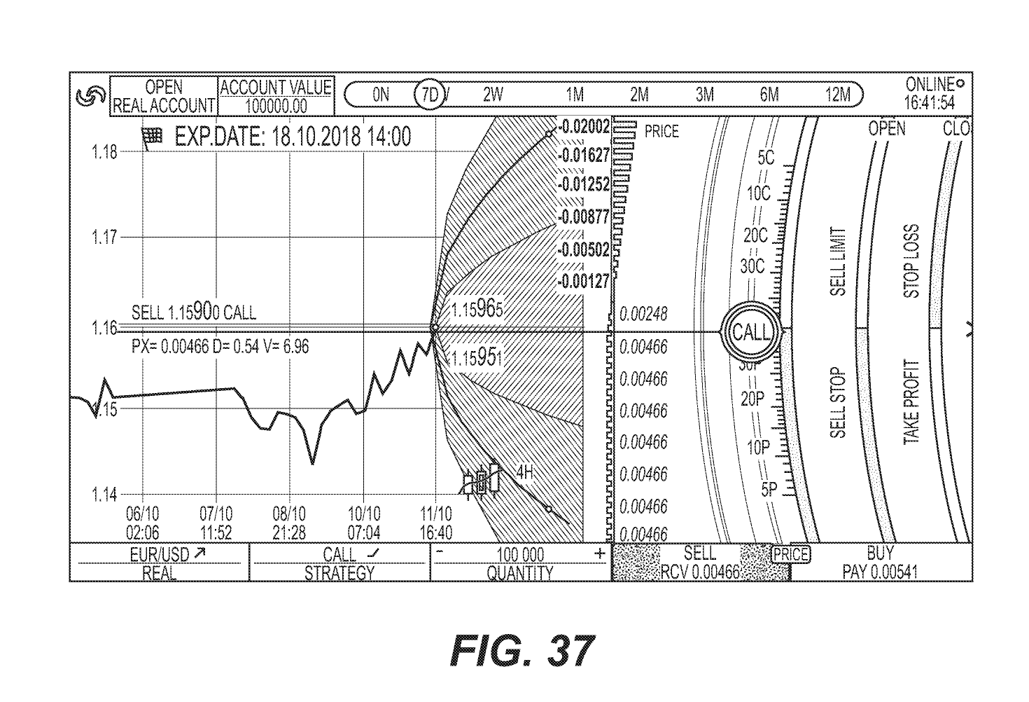

FIG. 33-42 illustrate the limit panel 700. In FIG. 33, the trading screen is set to trade a call option on the EUR/USD asset for one week expiration.

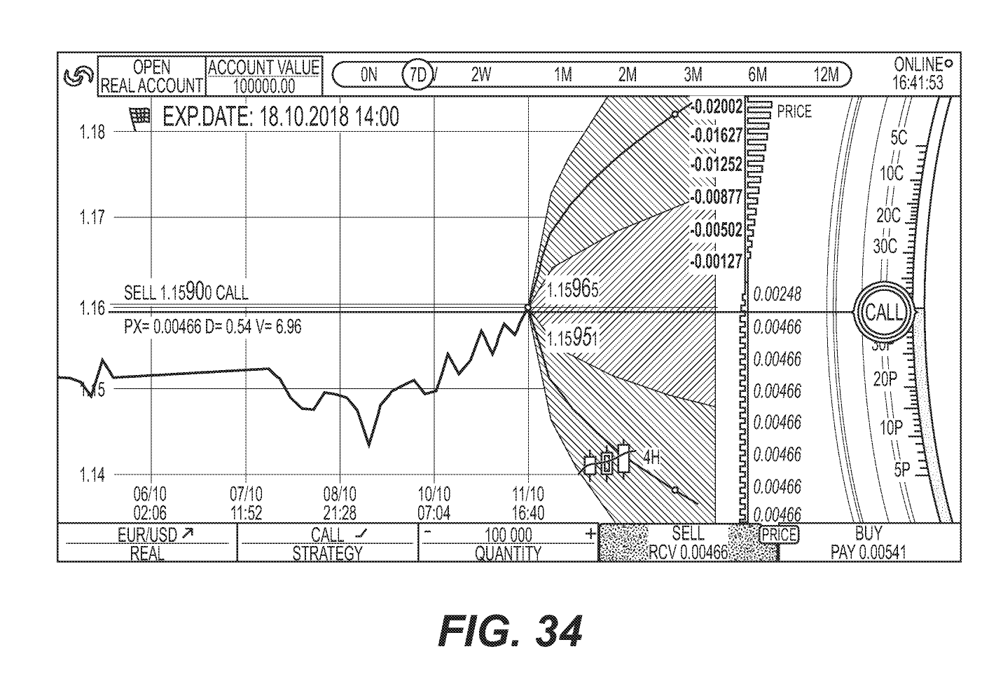

In FIG. 34, the user has just touched the button labeled “LIMIT” on the rightmost edge of the screen in order to activate the limit panel. In order to accommodate the limit panel, which may occupy approximately 25% of the display, other elements of the chart squeeze left; no information is lost and the same ranges are charted. This is shown progressively in FIGS. 34-38.

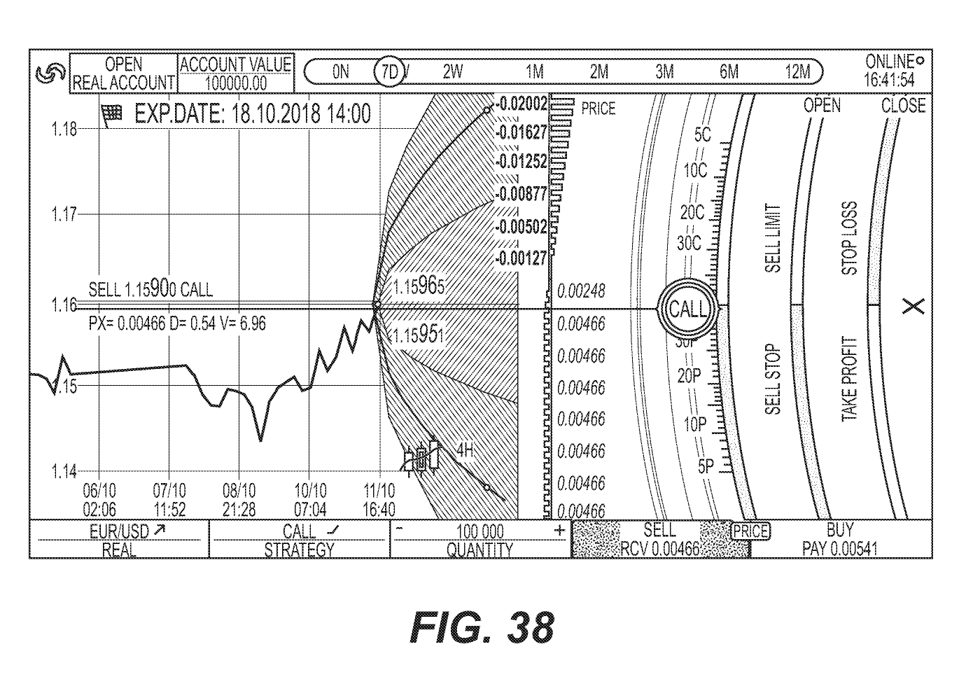

In FIG. 38, the animation is complete, and an “X” has appeared on the right edge of the screen to show the user how to close the limit panel back down, and remove any limit orders.

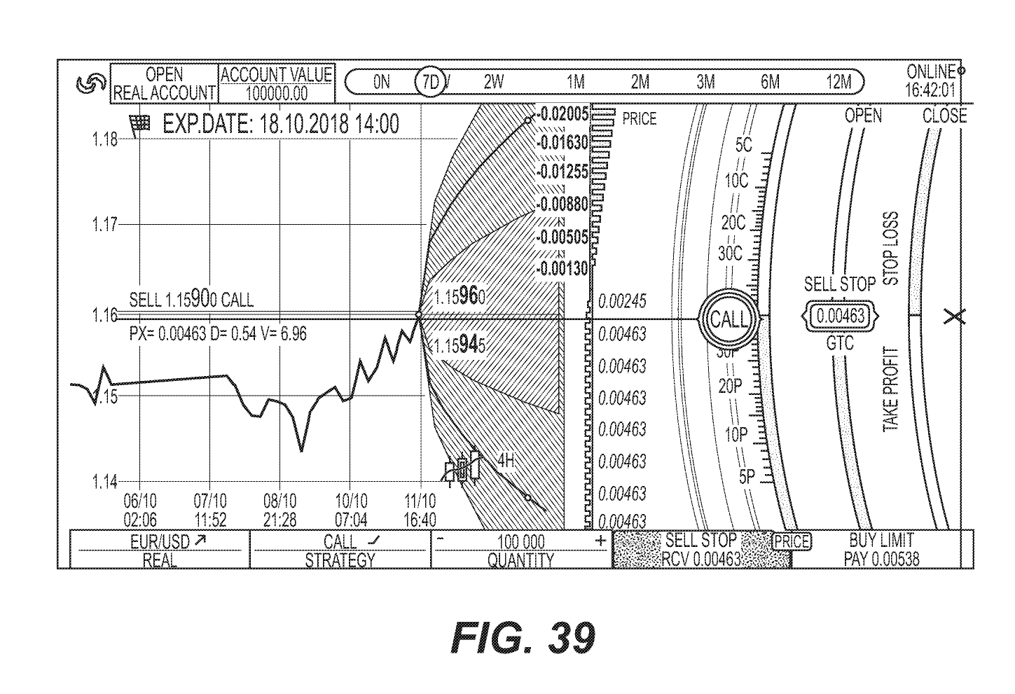

In FIG. 39, the user clicks on the OPEN LIMIT panel to create a SELL STOP order to enter the trade at a price that is worse than the current market price for the option. This typically means that if the market price is declining, the user believes this is the start of a trend, and wants to get into the trade by “chasing” it lower. By default, the order is labeled “GTC” which stands for “good til canceled.”. The order will be in force until the user cancels it. If the user long-presses the order handle, a pop-up dialogue allows the user to change the type of order to Good until End Of Day (“EOD”) or Good until End of Week (“GTW”).

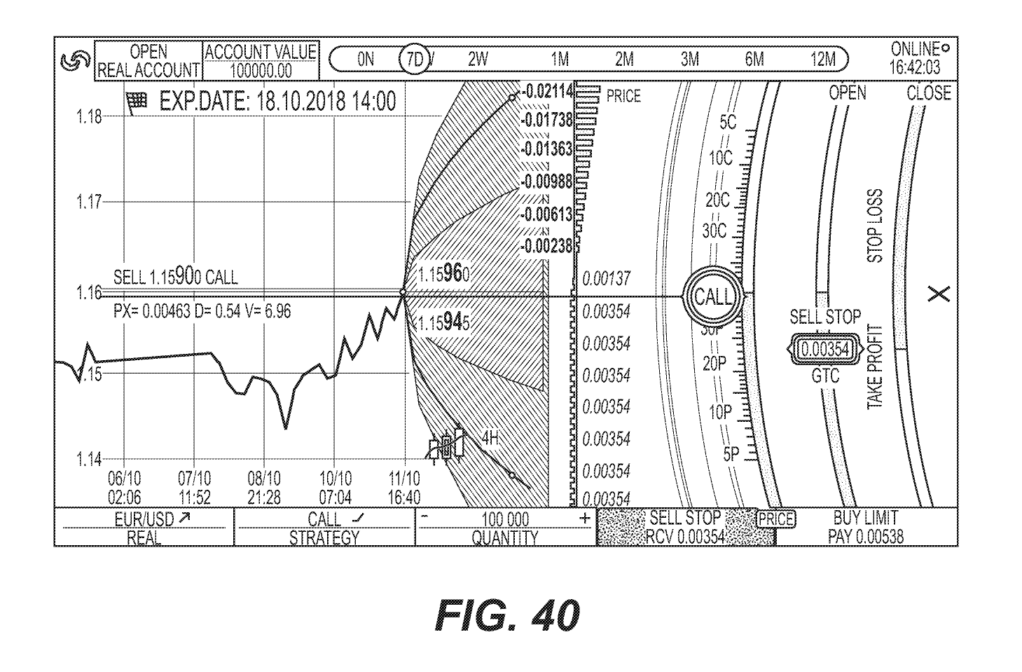

In FIG. 40, the user has dragged the SELL STOP order down to a new order level of 0.00354, which means the user wants to enter the trade, selling the call, after the bid price of the option has dropped to 0.00354.

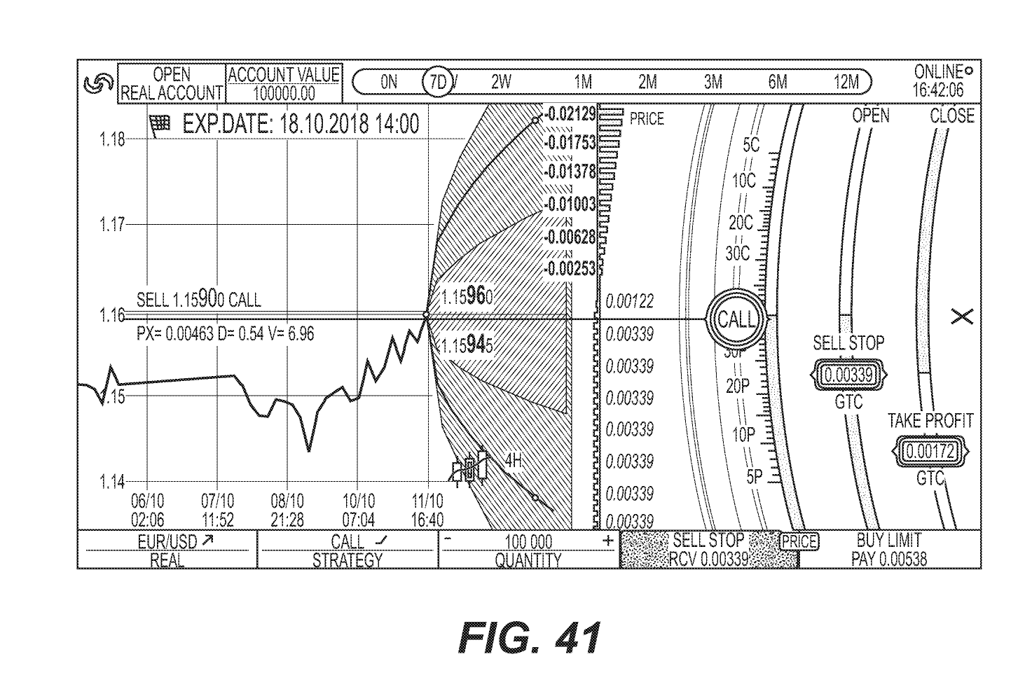

In FIG. 41, we see that the user has dragged the SELL STOP ever further down to 0.00339 which can be compared to the actual current market price of 0.00463 as shown under the blue Strike line on the left side of the page. In addition, the user now adds a TAKE PROFIT order at 0.00172. So if the user manages to sell to their open position after the option price has fallen to 0.00339, the user would like to leave a “TAKE PROFIT” order, or Limit Order, to buy the option back at 0.00172, thereby locking in the profit of 0.00167.

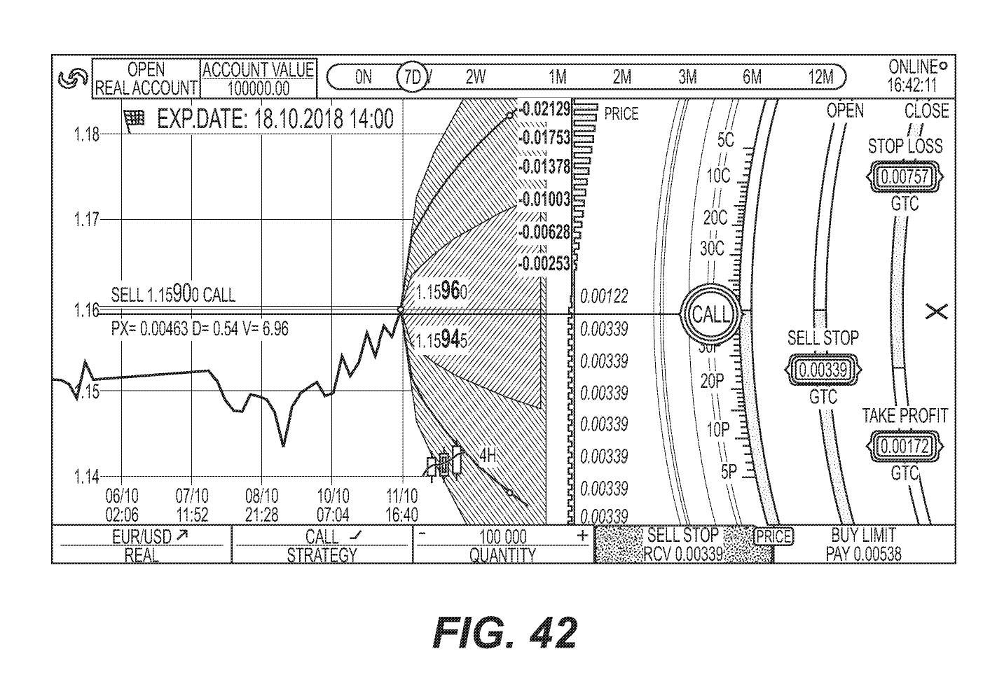

In FIG. 42, the user adds one more “contingent” order to the proposed trade. The user places a second closing order, a “STOP LOSS” order at a price of 0.00757. If the user gets the entry order filled to sell the option at 0.00339, and then the market price of the call option starts to rise, the user wants to limit their losses at 0.00757 for a net loss of 0.00418 depending on actual executions.

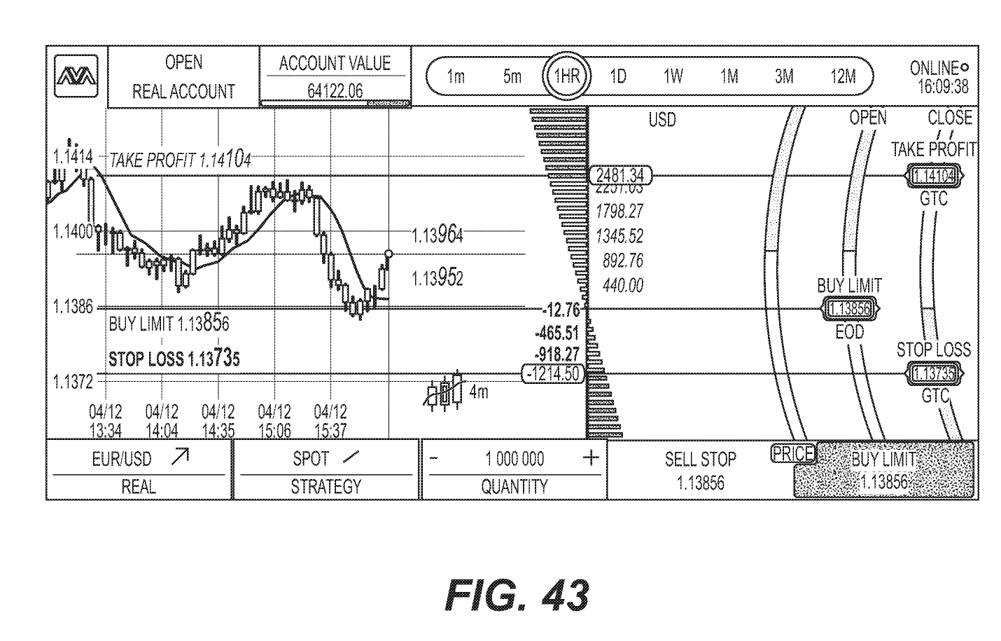

FIG. 43 shows a user preparing to trade an underlying instrument, EUR/USD spot, with both entry (“open”) and exit (“close”) limits. The user is setting up to buy the underlying asset, with an entry buy limit price of 1.13856 (702) which is lower than the prevailing market ask price 810 for the instrument. The trading system 200 labels this automatically as a “Buy Limit.” The user has set the time frame for the entry order to “EOD” which means the order is in effect until the end of the trading day; if not fulfilled by that time, the order will automatically cancel. The time slider 500 selection shows “1 HR,” so that one hour of historical data has been retrieved from the application middleware server 208 and is displayed in a historical data panel 800, as chosen by the user via the data format selector 806. In addition, this historical price chart shows a moving average price of historical prices in a user selected color, set up via the data format selector 806. The user has added two closing order levels; one is a “take profit” limit order using the close limit handle 706 at 1.14104 as displayed in the handle, and the other is a stop loss order using the stop loss handle 704 at 1.13735. The open and close limit order levels are supported visually by horizontal lines extending across the interface, extending left from the limit handles across the profit and loss diagram, across the historical price chart, ending at the Y-axis. In one implementation, these lines are colored and labeled for clarity, orange for entry limit, red for close stop loss and green for close take profit orders. These limit order lines interact with the profit and loss diagram in a clear way, such that above the take profit line, the profit and loss diagram is greyed out, and below the stop loss line, the profit and loss diagram is also greyed out. The grey coloring of the profit and loss chart 600 shows the user that his profit and loss potential are limited by the take profit and stop loss orders. Where these close limit order lines intersect the profit and loss diagram, further information is provided in numeric form, showing the user the expected profit if the entry order limit is filled, and then the take profit order limit is reached, and similarly showing the user the expected loss if the entry order limit is filled, and then the stop loss order if filled, closing the trade at a loss. All these elements update in real time as the live market price of the trading instrument updates, and as the user moves the order levels higher and lower.

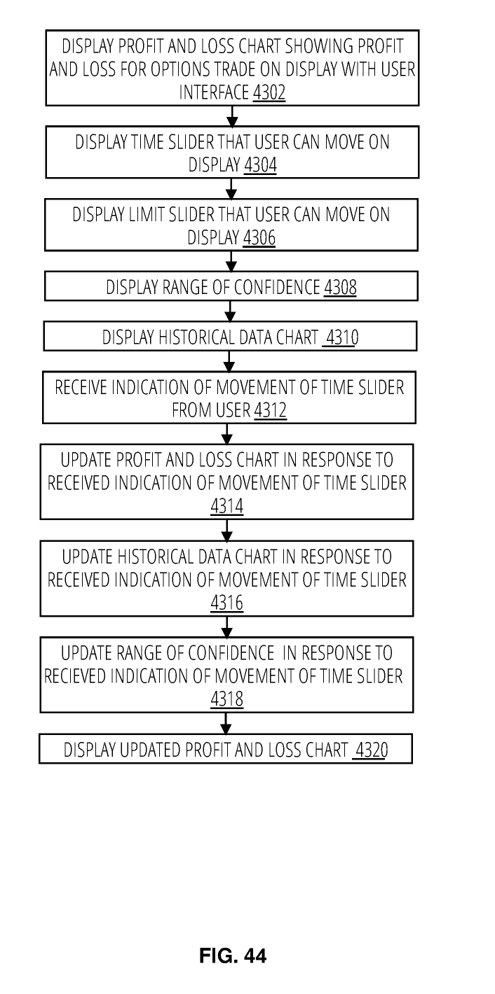

FIG. 44 illustrates steps in an exemplary method. The application 108 displays a profit-and-loss chart 600 showing the profit and loss for a trade on a financial derivative, such as an option, on a display with a user interface (step 4402). The application 108 displays a time slider that the user can move on the display (step 4404). Application 108 displays a limit slider that the user can move on the display (step 4406). The application may also display a range of confidence arc (4408) and a historical data chart (step 4410). The application 108 and trading system 200 receives an indication of movement of the time slider from the user (step 4412). Then the trading system 200 updates the profit and loss chart in response to receive indication of movement of the time slider (step 4414). The system also updates the historical data chart (step 4416) and range of confidence arc (step 4418) in response to the received indication of movement of the time slider. The system displays the updated profit and loss chart (step 4420), as well as any other applicable updates such as the range of confidence arc and the historical data chart. These steps may also be applied to other strategies, such as the spot trade with limit orders as shown in FIG. 43.

The foregoing description of various embodiments provides illustration and description, but is not intended to be exhaustive or to limit the invention to the precise form disclosed. Modifications and variations are possible in light of the above teachings or may be acquired from practice. It is to be understood that the invention is intended to cover various modifications and equivalent arrangements included within the spirit and scope of the claims.

What is claimed is:

1. A method in a data processing for trading a derivative of a financial instrument, comprising:
displaying a profit and loss chart showing the one of: (1) a profit and (2) a loss for a trade of a derivative of the financial instrument on a display;
displaying a time slider that a user can move on the display;
displaying a limit slider that the user can move on the display;
receiving an indication of movement of the time slider from the user;
updating the profit and loss chart in response to the indication of movement of the time slider from the user; and
displaying the updated profit and loss chart on the display.

2. The method of claim 1, wherein the derivative is an option, and the financial instrument is a stock.

3. The method of claim 2, wherein the time slider is an expiration date slider for the expiration date of an option.

4. The method of claim 1, further comprising displaying a range of confidence indicator, and updating the range of confidence indicator in response to the indication of movement of the time slider.

5. The method of claim 4, wherein the range of confidence indicator is an arc.

6. The method of claim 1, modifying the profit and loss chart on the display in real-time as the user moves the time slider.

7. The method of claim 1, further comprising displaying a historical data chart on the display and updating the historical data chart on the displaying in response to the indication of movement of the time slider from the user.

8. The method of claim 1, further providing a strike price indicator that the user can move on the display.

9. The method of claim 8, further comprising:
receiving an indication of movement of the limit slider from the user; and
updating the profit and loss chart in response to the indication of movement of the limit slider.

10. A data processing system for trading a derivative of a financial instrument, comprising:
a display;
a processor configured to execute instructions stored in a memory; and
the memory storing the instructions that, when executed by the processor, cause the processor to:
display a profit and loss chart showing the one of: (1) a profit and (2) a loss for a trade of a derivative of the financial instrument on a display;
display a time slider that a user can move on the display;
display a limit slider that the user can move on the display;
receive an indication of movement of the time slider from the user;
update the profit and loss chart in response to the indication of movement of the time slider from the user; and
display the updated profit and loss chart on the display.

11. The data processing system of claim 10, wherein the derivative is an option, and the financial instrument is a stock.

12. The data processing system of claim 11, wherein the time slider is an expiration date slider for the expiration date of an option.

13. The data processing system of claim 10, wherein the instructions further configure the processor to display a range of confidence indicator, and updating the range of confidence indicator in response to the indication of movement of the time slider.

14. The data processing system of claim 13, wherein the range of confidence indicator is an arc.

15. The computing apparatus of claim 10, modify the profit and loss chart on the display in real-time as the user moves the time slider.

16. The computing apparatus of claim 10, wherein the instructions further configure the apparatus to display a historical data chart on the display and updating the historical data chart on the displaying in response to the indication of movement of the time slider from the user.

17. The data processing system of claim 10, further comprising a strike price indicator that the user can move on the display.

18. The data processing system of claim 17, wherein the instructions further configure the processor to:
receive an indication of movement of the limit slider from the user; and
update the profit and loss chart in response to the indication of movement of the limit slider.

19. A method in a data processing for trading an option on a stock, comprising:
displaying a profit and loss chart showing the one of: (1) a profit and (2) a loss for a trade of the option on a display;
displaying a time slider that a user can move on the display;
displaying a limit slider that the user can move on the display;
displaying a historical data chart;
displaying a range of confidence indicator;
receiving an indication of movement of the time slider from the user;
updating the profit and loss chart, range of confidence indicator, and historical data chart in response to the indication of movement of the time slider from the user; and
displaying the updated profit and loss chart on the display.

20. The method of claim 19, further comprising:
receiving an indication of movement of a strike price slider from a user; and
updating the profit and loss chart, range of confidence indicator, and historical data chart in response to the indication of movement of the strike price slider from the user.
